(19) United States
(12) Patent Application Publication
(10) Pub. No.: US 2025/0168906 A1
(43) Pub. Date: May 22, 2025

(54) INFORMATION UPDATING METHOD AND ELECTRONIC DEVICE

(71) Applicant: GUANGDONG OPPO MOBILE TELECOMMUNICATIONS CORP., LTD., Dongguan (CN)

(72) Inventor: Jianquan BAO, Dongguan (CN)

(73) Assignee: GUANGDONG OPPO MOBILE TELECOMMUNICATIONS CORP., LTD., Dongguan (CN)

(21) Appl. No.: 19/029,302

(22) Filed: Jan. 17, 2025

Related U.S. Application Data
(63) Continuation of application No. PCT/CN2023/102448, filed on Jun. 26, 2023.

(30) Foreign Application Priority Data
Jul. 21, 2022 (CN) 20222108647014.4

(51) Int. Cl. H04W 76/10; H04W 8/00

(52) U.S. Cl. CPC H04W 76/10; H04W 8/005

(57) ABSTRACT

An information updating method and an electronic device are provided. The information updating method is performed by an electronic device. The method includes: obtaining target set information, the target set information being configured to indicate a target Bluetooth device set: sending the target set information to N first Bluetooth devices of a first Bluetooth device set, enabling the first Bluetooth devices to update first set information to the target set information; and sending the target set information to M second Bluetooth devices of a second Bluetooth device set, enabling the second Bluetooth devices to update second set information to the target set information.

### CROSS-REFERENCES TO RELATED APPLICATIONS

This application is a continuation of International Patent Applicant NO. PCT/CN 2023/102448, filed Jun. 26, 2023, which claims priority to Chinese Patent Application No. 202210864701.4 filed Jul. 21, 2022, both of which are herein incorporated by reference in their entireties.

### TECHNICAL FIELD

The present disclosure relates to the field of communication technologies, and in particular to an information updating method and electronic device.

### BACKGROUND

The Bluetooth is a kind of radio technology that supports short-range communication between devices, enabling wireless information exchange between a plurality of electronic devices that support a Bluetooth transmission function, such that data transmission between the electronic devices are faster and more efficient. Many Bluetooth devices available on the market may form a device set for use. For example, Bluetooth earphones, Bluetooth speaker systems, and so on, may all operate in a collaborative manner as a Bluetooth device set.

However, in certain application scenarios, users often need to make Bluetooth devices from different device sets to operate in a collaborative manner. For example, regarding scenarios where the users want to make different pairs of Bluetooth earphone to share music transmitted from a cell phone, etc., there is currently no good solution.

### SUMMARY

According to a first aspect, the present disclosure provides an information updating method performed by an electronic device. The method includes: obtaining target set information, wherein the target set information is configured to indicate a target Bluetooth device set; sending the target set information to N first Bluetooth devices of a first Bluetooth device set, enabling the N first Bluetooth devices to update first set information to the target set information, wherein the first set information is configured to indicate a first Bluetooth device set, N is an integer greater than 1; sending the target set information to M second Bluetooth devices of a second Bluetooth device set, enabling the M second Bluetooth devices to update second set information to the target set information, wherein the second set information is configured to indicate a second Bluetooth device set, M is an integer greater than 1.

According to a second aspect, the present disclosure provides an information updating method performed by a first Bluetooth device. The method includes: receiving the target set information sent by the electronic device, wherein the target set information is configured to indicate the target Bluetooth device set; updating the first set information to the target set information, wherein the first set information is configured to indicate the first Bluetooth device set; the N first Bluetooth devices that have updated the first set information to the target set information and the M second Bluetooth devices that have updated the second set information to the target set information are all recognized as belonging to the target Bluetooth device set; wherein the second set information is configured to indicate the second Bluetooth device set, both N and M are integers greater than 1.

The present disclosure provides an electronic device. The electronic device includes a memory, a processor and a communication unit. the memory stores a computer program. The computer program, when being executed by the processor, enables the electronic device to implement an information updating method. The method includes: obtaining target set information, wherein the target set information is configured to indicate a target Bluetooth device set; sending the target set information to N first Bluetooth devices of a first Bluetooth device set, enabling the N first Bluetooth devices to update first set information to the target set information, wherein the first set information is configured to indicate a first Bluetooth device set, N is an integer greater than 1; sending the target set information to M second Bluetooth devices of a second Bluetooth device set, enabling the M second Bluetooth devices to update second set information to the target set information, wherein the second set information is configured to indicate a second Bluetooth device set, M is an integer greater than 1.

Details of one or more embodiments of the present disclosure are set forth in the accompanying drawings and description below. Other features, and beneficial effects of the present disclosure will be embodied in the specification, the accompanying drawings, and the claims.

### BRIEF DESCRIPTION OF THE DRAWINGS

To more clearly illustrate technical solutions of embodiments in the present disclosure, the drawings required in the description of the embodiments will be briefly introduced below. Obviously, the drawings in the following description are only some embodiments of the present disclosure. For those of ordinary skills in the art, other drawings may be obtained based on these drawings without creative efforts.

FIG. 1A is an application scenario diagram of an information updating method and an audio sharing method according to an embodiment of the present disclosure.

FIG. 1B is an application scenario diagram of an information updating method and an audio sharing method according to another embodiment of the present disclosure.

FIG. 1C is an application scenario diagram of an information updating method and an audio sharing method according to yet another embodiment of the present disclosure.

FIG. 2 is a schematic timing diagram of an information updating method according to an embodiment of the present disclosure.

FIG. 3 is a flowchart of an information updating method according to an embodiment of the present disclosure.

FIG. 4A is a schematic timing diagram of an information updating method according to another embodiment of the present disclosure.

FIG. 4B is a schematic timing diagram of an information updating method according to yet another embodiment of the present disclosure.

FIG. 5 is a flowchart of an information updating method according to another embodiment of the present disclosure.

FIG. 6 is a schematic structural diagram of an LE Audio broadcasting signal according to an embodiment of the present disclosure.

FIG. 7A is a schematic timing diagram illustrating that N first Bluetooth devices and M second Bluetooth devices sharing audio data transmitted by a terminal device according to an embodiment of the present disclosure.

FIG. 7B is a schematic timing diagram illustrating that the N first Bluetooth devices and the M second Bluetooth devices sharing the audio data transmitted by a terminal device according to another embodiment of the present disclosure.

FIG. 8 is a flowchart of an information updating method according to yet another embodiment of the present disclosure.

FIG. 9 is a flowchart of an audio sharing method according to an embodiment of the present disclosure.

FIG. 10 is a block diagram of an information updating apparatus according to an embodiment of the present disclosure.

FIG. 11 is a block diagram of an information updating apparatus according to another embodiment of the present disclosure.

FIG. 12 is a structural block diagram of an electronic device according to an embodiment of the present disclosure.

### DETAILED DESCRIPTION

Technical solutions in embodiments of the present disclosure will be described clearly and thoroughly in connection with accompanying drawings of the embodiments of the present disclosure. Obviously, the described embodiments are only part of the embodiments, but not all of them. All other embodiments occur to a person of ordinary skills in the art based on embodiments of the present disclosure without creative efforts shall all be within the protection scope of the present disclosure.

The terms “have”, “include”, “comprise” and any variations thereof in some embodiments and the accompanying drawings of the present disclosure are intended to cover non-exclusive inclusion. For example, a process, a method, a system, a product, or a device that includes a series of operations or units is not limited to the listed operations or units, but optionally includes unlisted operations or units, or optionally further includes other operations or units inherent to these processes, methods, products or devices.

The terms “first”, “second”, and the like as used in the present disclosure may be used herein to describe various components, but these components are not limited by these terms. These terms are used only to distinguish a first component from another one. For instance, without departing from the scope of the present disclosure, a first Bluetooth device may be referred to as a second Bluetooth device. Similarly, the second Bluetooth device may be referred to as the first Bluetooth device. The first Bluetooth device and the second Bluetooth device are both Bluetooth devices, but they are not a same Bluetooth device. In the present disclosure, the adopted term “a plurality of” means two, or more than two. The term “and/or” adopted in the present disclosure refers to one of the technical schemes, or an arbitrary combination of a plurality of technical schemes.

In certain application scenarios, users often need to make Bluetooth devices from different device sets to operate in the collaborative approach. For example, scenarios where the users want to make different pairs of Bluetooth earphones to share music transmitted from a cell phone, etc. In the related art, there are two solutions for the audio sharing between different pairs of Bluetooth earphones. The first solution involves that, a terminal device transmits the audio data to one pair of Bluetooth earphones, which then forwards the audio data to another pair of Bluetooth earphones, thereby achieving audio sharing. The second solution is based on a broadcast mechanism in the Bluetooth low energy (BLE) technology, where the terminal device uses a BLE broadcast to transmit the audio data to different pairs of Bluetooth earphones, thereby achieving audio sharing, and so on.

For the above-mentioned first kind of audio sharing approach, additional hardware or customized chips may be required to enable an audio sharing function, which may increase cost and result in poor compatibility. For the above-mentioned second kind of audio sharing approach, since the audio data transmission is performed via BLE broadcast without connection, the transmission reliability may not be guaranteed.

The embodiments of the present disclosure provide an information updating method and an information updating apparatus, an audio sharing method and an audio sharing system, an electronic device, and a storage medium, which are able to dynamically and flexibly combine Bluetooth devices from different device sets into a same Bluetooth device set for collaborative use, thereby meeting the user's usage requirements. In addition, the audio sharing between N first Bluetooth devices and M second Bluetooth devices may be achieved, and the reliability of the audio data transmission may be enhanced.

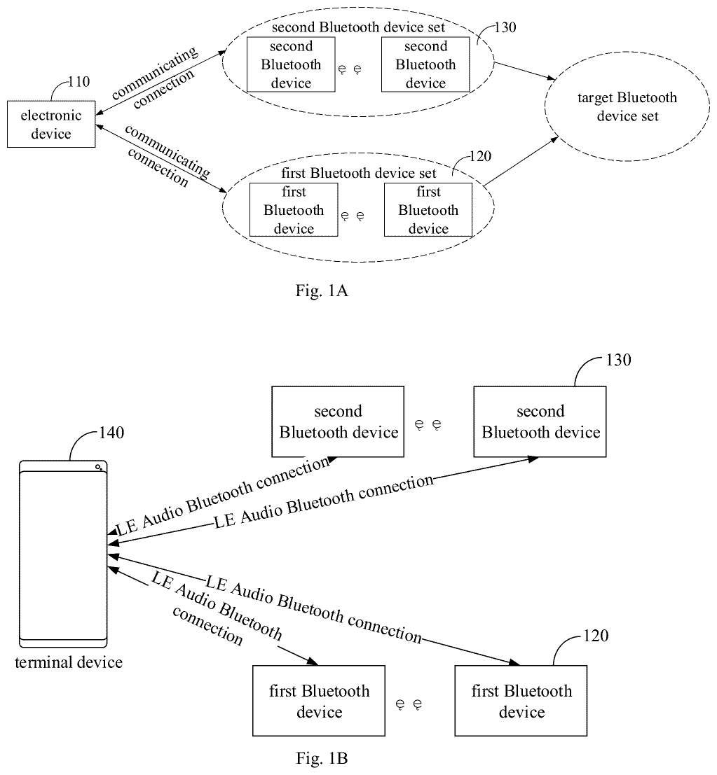

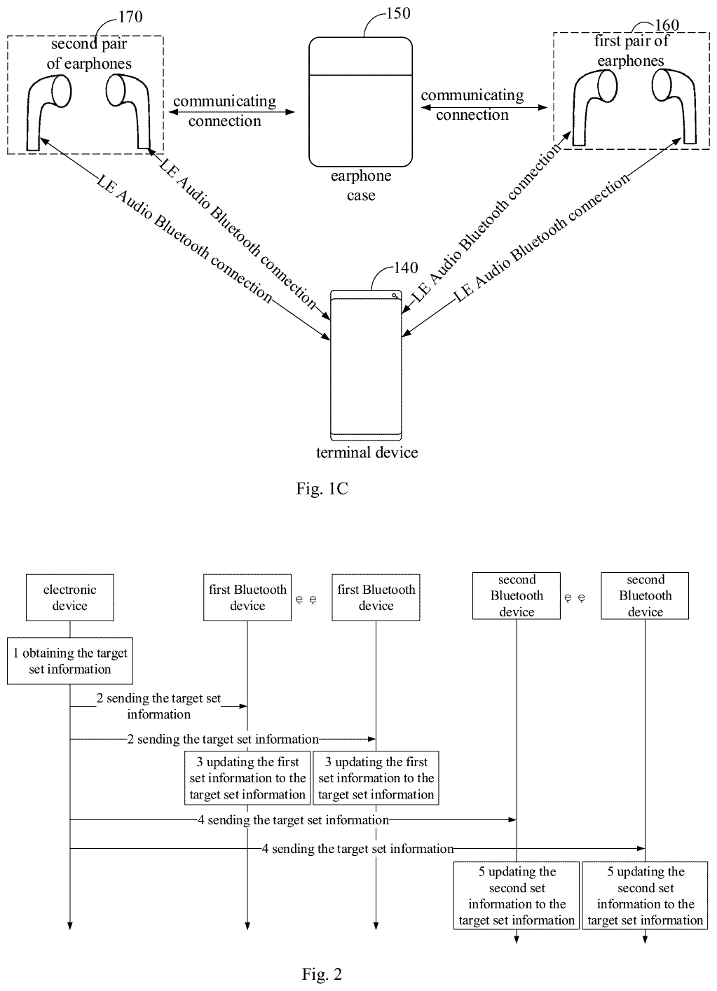

FIG. 1A is an application scenario diagram of an information updating method and an audio sharing method according to an embodiment of the present disclosure. As illustrated in FIG. 1A, a first Bluetooth device set may include N first Bluetooth devices 120, and a second Bluetooth device set may include M second Bluetooth devices 130. Each of N and M is an integer greater than 1. The first Bluetooth devices 120 and the second Bluetooth devices 130 may include, but are not limited to, devices such as headphones, cell phones, wearable devices, speaker devices, smart home devices etc. In some embodiments, the first Bluetooth devices 120 and/or the second Bluetooth devices 130 may be true wireless stereo (TWS) earphones. The first Bluetooth devices 120 and the second Bluetooth devices 130 may be a same kind of Bluetooth device or may be different kinds of Bluetooth devices.

The electronic device 110 may be a device that is capable of establishing communicating connections with the first Bluetooth devices 120 and the second Bluetooth devices 130. As an example, the electronic device 110 may be an electronic device that is used in conjunction with the first Bluetooth devices 120 and the second Bluetooth devices 130. For example, and without limitation, each of the first Bluetooth devices 120 and the second Bluetooth devices 130 is an earphone, and the electronic device 110 may be an earphone case etc. The electronic device 110 may also include, but is not limited to, a cell phone, a smart wearable device, a vehicle-mounted terminal device, a tablet computer, a personal computer (PC), a personal digital assistant (PDA), etc.

Each Bluetooth device may be configured with set information. This set information may be configured to indicate a Bluetooth device set to which this Bluetooth device belongs. In some embodiments, this set information may include combination identification information. Bluetooth devices belonging to different Bluetooth device sets may match with different combination identification information. This combination identification information may be configured to identify the Bluetooth device set to which the Bluetooth device belongs. Bluetooth devices belonging to the same Bluetooth device set may match with the same combination identification information. External devices may recognize a plurality of Bluetooth devices as a single Bluetooth device set through this combination identification information, thereby realizing an object that the Bluetooth devices that belong to the same Bluetooth device set may be used in a coordinated and synchronized manner. For example, the N first Bluetooth devices 120 in the first Bluetooth device set may match with the same first combination identification information, the M second Bluetooth devices 130 in the second Bluetooth device set may match with the same second combination identification information, and the first combination identification information is different from the second combination identification information. In this way, it may be ensured that, the N first Bluetooth devices 120 of the first Bluetooth device set and the M second Bluetooth devices 130 of the second Bluetooth device set would not be confused with each other during use.

In some embodiments of the present disclosure, it may be achieved that, the N first Bluetooth devices 120 originally belonging to the first Bluetooth device set and the M second Bluetooth devices 130 originally belonging to the second Bluetooth device set are successfully configured to be belonging to a target Bluetooth device set for collaborative usage. The electronic device 110 may establish communicating connection with the N first Bluetooth devices 120 of the first Bluetooth device set, and send the target set information to the N first Bluetooth devices 120, such that the N first Bluetooth devices 120 may update the first set information to this target set information. The electronic device 110 may establish communicating connection with the M second Bluetooth devices 130 of the second Bluetooth device set, and send the target set information to the M second Bluetooth devices 130, such that the M second Bluetooth devices 130 may update the second set information to this target set information. The target set information is configured to indicate the target Bluetooth device set. The N first Bluetooth devices 120 and the M second Bluetooth devices 130, after updating to the target set information, may successfully join the target Bluetooth device set, thereby allowing the N first Bluetooth devices 120 and the M second Bluetooth devices 130 to be recognized as belonging to the same Bluetooth device set for collaborative use.

The above-mentioned communicating connection may include, but is not limited to, wireless communicating connection such as Bluetooth etc. This Bluetooth communicating connection may include, but is not limited to, any of the following: a classic Bluetooth connection, a Bluetooth low energy (BLE) connection, an LE Audio Bluetooth connection, etc. In some embodiments, the above-mentioned communicating connection may also be physical connection approach such as contact-type contact-point communicating connection etc. The specific communicating connection approach is not specifically restricted in the present disclosure.

FIG. 1B is an application scenario diagram of the information updating method and the audio sharing method according to another embodiment of the present disclosure. As illustrated in FIG. 1B, after the N first Bluetooth devices 120 have updated the first set information to the target set information, and the M second Bluetooth devices 130 have update the second set information to the target set information, all the N first Bluetooth devices 120 and the M second Bluetooth devices 130 that belong to the target Bluetooth device set may send a Bluetooth broadcasting signal based on the target set information. The terminal device 140 may establish, according to the scanned Bluetooth broadcasting signal, the Bluetooth connection with the N first Bluetooth devices 120 and the M second Bluetooth devices 130, respectively. For example, the N first Bluetooth devices 120 and the M second Bluetooth devices 130 may send the LE Audio broadcasting signal based on the target set information. The terminal device 140 may establish, according to the scanned LE Audio broadcasting signal, the LE Audio Bluetooth connection with the N first Bluetooth devices 120 and with the M second Bluetooth devices 130, respectively. After the terminal device establishes the LE Audio Bluetooth connection with the N first Bluetooth devices 120 and with the M second Bluetooth devices 130, the terminal device may establish an audio transmission channel (such as a connected isochronous streams (CIS) etc.) with the N first Bluetooth devices 120 and with the M second Bluetooth devices 130 based on the LE Audio Bluetooth connection. Through this audio transmission channel, the terminal device may transmit the audio data to the various first Bluetooth devices 120 and to the various second Bluetooth devices 130, thereby enabling the audio sharing between the N first Bluetooth devices 120 and the M second Bluetooth devices 130. The various CIS channels established between the terminal device and the N first Bluetooth devices 120 and the M second Bluetooth devices 130 may form a connected isochronous group (CIG). The various CIS channels within the same CIG have a same timestamp, thereby ensuring that the audio data received within the CIG is synchronized.

In some embodiments, the various Bluetooth devices in the target Bluetooth device set may be assigned different roles. For example, a left earphone plays a left channel audio, and a right earphone plays a right channel audio.

The terminal device 140 may also include, but is not limited to, the cell phone, the smart wearable device, the vehicle-mounted terminal device, the tablet computer, the PC, the PDA, etc.

FIG. 1C is an application scenario diagram of the information updating method and the audio sharing method according to yet another embodiment of the present disclosure. As illustrated in FIG. 1C, the above-mentioned electronic device 110 may include an earphone case 150, the first Bluetooth device set may include a first pair of earphones 160, the second Bluetooth device set may include a second pair of earphones 170. To meet the user's demand for collaborative use of the first pair of earphones 160 and the second pair of earphones 170, the first pair of earphones 160 and the second pair of earphones 170 may be configured, through the earphone case 150, to be belonging to the same Bluetooth device set for use. As an implementation embodiment, the user may place both the first pair of earphones 160 and the second pair of earphones 170 inside the earphone case 150, respectively. For example, the first pair of earphones 160 may be first placed inside the earphone case 150, and then the second pair of earphones 170 may be placed inside the earphone case 150. In a case where the first pair of earphones 160 is placed inside the earphone case 150, the earphone case 150 may send the target set information to both the left earphone and the right earphone of the first pair of earphones 160. The left earphone and the right earphone of the first pair of earphones 160 may update the first set information to this target set information. In a case where the second pair of earphones 170 is placed inside the earphone case 150, the earphone case 150 may send the target set information to both the left earphone and the right earphone of the second pair of earphones 170. The left earphone and the right earphone of the second pair of earphones 170 may update the second set information to this target set information.

After the left earphone and the right earphone of the first pair of earphones 160 update the first set information to the target set information, and the left earphone and the right earphone of the second pair of earphones 170 update the second set information to the target set information, all the first pair of earphones 160 and the second pair of earphones 170 successfully join the same Bluetooth device set. The left earphone and the right earphone of the first pair of earphones 160, as well as the left earphone and the right earphone of the second pair of earphones 170, may each establish the LE Audio Bluetooth connection with the terminal device 140 based on the target set information, respectively. The terminal device 140 may send the audio data to the first pair of earphones 160 and to the second pair of earphones 170, respectively, thereby enabling the first pair of earphones 160 and the second pair of earphones 170 to share the audio data transmitted by the terminal device 140.

Further, the terminal device 140 may send the left channel audio data to the left earphone of the first pair of earphones 160 and to the left earphone of the second pair of earphones 170, respectively, and the terminal device 140 may send the right channel audio data to the right earphone of the first pair of earphones 160 and to the right earphone of the second pair of earphones 170, respectively.

the above-mentioned electronic device 110 may also configure Bluetooth devices originally belonging to two or more different Bluetooth device sets to belong to the same Bluetooth device set for collaborative use. The two or more different Bluetooth device sets are not limited to the above-mentioned first Bluetooth device set and the second Bluetooth device set. For example, but without limitation, the Bluetooth devices originally belonging to 3 or 4 different Bluetooth device sets may be configured to belong to the same Bluetooth device set for collaborative use etc.

FIG. 2 is a schematic timing diagram of the information updating method according to an embodiment of the present disclosure. As illustrated in FIG. 2, this information updating method may include the following operations.
Operation 1: the electronic device obtains the target set information.
Operation 2: the electronic device sends the target set information to the N first Bluetooth devices of the first Bluetooth device set.
Operation 3: the N first Bluetooth devices update the first set information to the target set information.
Operation 4: the electronic device sends the target set information to the M second Bluetooth devices of the second Bluetooth device set.
Operation 5: the M second Bluetooth devices update the second set information to the target set information.

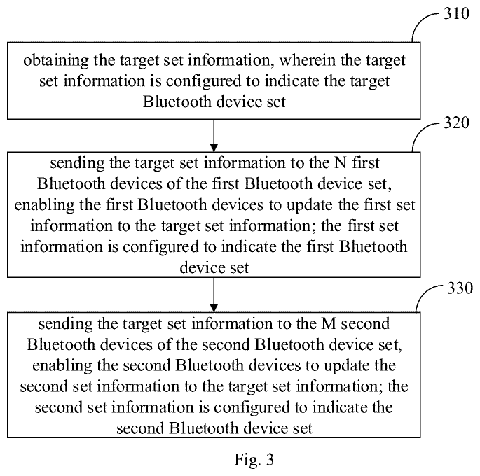

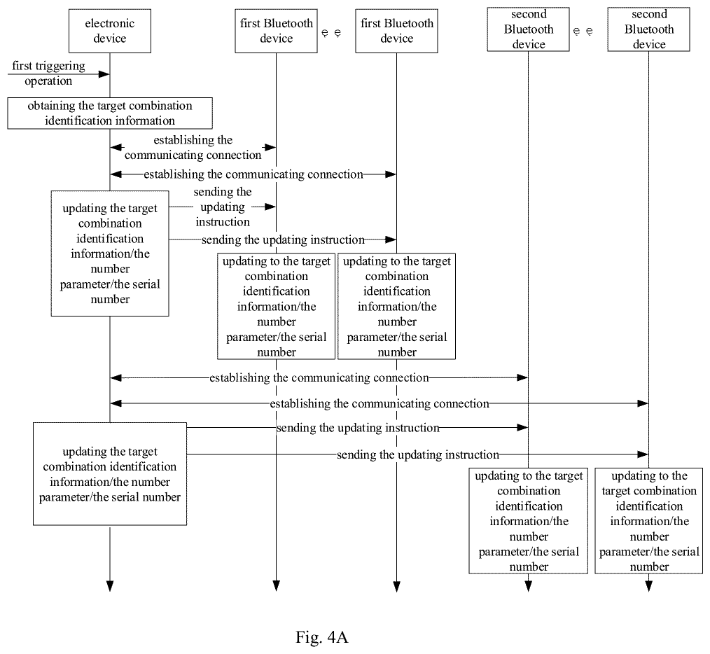

As illustrated in FIG. 3, in some embodiments, the information updating method that may be performed by the above-mentioned electronic device is provided. The method may include the following operations at blocks illustrated in FIG. 3.

The operation at block 310: obtaining the target set information, wherein the target set information is configured to indicate the target Bluetooth device set.

The N first Bluetooth devices of the first Bluetooth device set and the M second Bluetooth devices of the second Bluetooth device set may be configured to be belonging to the same target Bluetooth device set through the electronic device. The electronic device may obtain the target set information, and send this target set information to the N first Bluetooth devices of the first Bluetooth device set and to the M second Bluetooth devices of the second Bluetooth device set, respectively, such that the first Bluetooth devices and the second Bluetooth devices may perform set information updating, thereby successfully joining the target Bluetooth device set.

In some embodiments, the user may perform a first triggering operation on the electronic device, so as to trigger a function that enable the electronic device to group the Bluetooth devices from different Bluetooth device sets into the same Bluetooth device set. in a case where the first triggering operation is detected, the electronic device may obtain, in a case of this first triggering operation, the target set information. The specific operation approach of this first triggering operation is not restricted in embodiments of the present disclosure. For example, the electronic device may be provided with a particular key. This particular key may be either a virtual key or a physical key. This first triggering operation may be a preset operation on this particular key, for example, press-and-hold for a period of time, clicking the particular key, double-clicking the particular key etc. For another example, the first triggering operation may be any of a touch operation, a gesture operation, a voice operation etc. The electronic device may, without limitation, detect this first triggering operation through a corresponding sensor. For example, the electronic device may detect a preset press operation through a pressure sensor, detect a preset gesture operation through a proximity sensor, detect a preset voice content through a voice sensor, etc.

As an example, taking a case where the electronic device is an earphone case as an example, the first triggering operation may include, without limitation, pressing and holding a pairing key on the earphone case, double-pressing the pairing key on the earphone case, performing a preset gesture operation on the earphone case, etc.

As an example, taking a case where the electronic device is a cell phone as an example, the cell phone may provide an audio sharing button on an interface. The first triggering operation may be, without limitation, clicking the audio sharing button.

The operation at block 320: sending the target set information to the N first Bluetooth devices of the first Bluetooth device set, enabling the first Bluetooth devices to update the first set information to the target set information. The first set information is configured to indicate the first Bluetooth device set.

The operation at block 330: sending the target set information to the M second Bluetooth devices of the second Bluetooth device set, enabling the second Bluetooth devices to update the second set information to the target set information. The second set information is configured to indicate the second Bluetooth device set.

The various first Bluetooth devices of the first Bluetooth device set may be configured with the first set information. It may be indicated, through this first set information, that the first Bluetooth devices belong to the first Bluetooth device set. The electronic device may establish the communicating connection with the N first Bluetooth devices of the first Bluetooth device set, and send the target set information to the N first Bluetooth devices respectively. After receiving the target set information sent by the electronic device, the first Bluetooth devices may update the first set information to the target set information. Thus, the first Bluetooth devices are successfully changed from belonging to the first Bluetooth device set to belonging to the target Bluetooth device set.

The various second Bluetooth devices of the second Bluetooth device set may be configured with the second set information. It may be indicated, through this second set information, that the second Bluetooth devices belong to the second Bluetooth device set. The electronic device may establish the communicating connection with the M second Bluetooth devices of the second Bluetooth device set, and send the target set information to the M second Bluetooth devices respectively. After receiving the target set information sent by the electronic device, the second Bluetooth devices may update the second set information to the target set information. Thus, the second Bluetooth devices are successfully changed from belonging to the second Bluetooth device set to belonging to the target Bluetooth device set.

The above-mentioned N and M may both be an integer greater than 1. N and M may be the same or different. For example, N and M are both 2. In some embodiments, N is 2, and M is 3, etc., but the present disclosure is not limited to these examples.

The specific connection approaches of the communicating connection between the electronic device and the first Bluetooth devices and the communicating connection between the electronic device and the second Bluetooth devices are not restricted in the present disclosure. Different communicating connection approaches may be selected for different electronic devices. For example, if the electronic device is a terminal device such as the cell phone, the tablet computer etc., this communicating connection approach may be the Bluetooth communicating connection etc. If the electronic device is a companion device matching with the first Bluetooth devices and/or with the second Bluetooth devices, such as when all the first Bluetooth devices and the second Bluetooth devices are earphones, and the electronic device is an earphone case, the communicating connection approach may be a contact-point communicating connection, etc.

The electronic device may first establish the communicating connection with the N first Bluetooth devices of the first Bluetooth device set, after sending the target set information to the N first Bluetooth devices, the electronic device may disconnect from the communicating connection with the N first Bluetooth devices, and then establish the communicating connection with the M second Bluetooth devices of the second Bluetooth device set. In some embodiments, the electronic device may first establish the communicating connection with the M second Bluetooth devices of the second Bluetooth device set, after sending the target set information to the M second Bluetooth devices, the electronic device may disconnect from the communicating connection with the M second Bluetooth devices, and then establish the communicating connection with the N first Bluetooth devices of the first Bluetooth device set. The electronic device may also simultaneously establish communicating connections with the N first Bluetooth devices of the first Bluetooth device set, as well as with the M second Bluetooth devices of the second Bluetooth device set, respectively. The chronological order or timing sequence for the electronic device to establish communicating connections with the first Bluetooth devices and with the second Bluetooth devices are not specifically restricted in the present disclosure.

The chronological order of the operation that the electronic device obtains the target set information, and the operation that the electronic device establishes the communicating connections with the first Bluetooth devices and with the second Bluetooth devices are not restricted in the present disclosure. For example, the operation that the electronic device obtains the target set information may be before the operation that the electronic device establishes the communicating connections with the N first Bluetooth devices and with the M second Bluetooth devices. The electronic device may first establish the communicating connections with the N first Bluetooth devices of the first Bluetooth device set, and then obtain the target set information.

In some embodiments, the target set information may include target combination identification information. This target combination identification information may be configured to identify the target Bluetooth device set. The first set information may include the first combination identification information. This first combination identification information may be configured to identify the first Bluetooth device set. The second set information may include the second combination identification information. This second combination identification information may be configured to identify the second Bluetooth device set. The first set information is different from the second set information. The first combination identification information is different from the second combination identification information, thereby ensuring that, the N first Bluetooth devices of the first Bluetooth device set and the M second Bluetooth devices of the second Bluetooth device set are used separately without confusion, before the set information is not updated. The target combination identification information may be different from both the first combination identification information and the second combination identification information. In some embodiments, the target combination identification information may be different from or the same as either the first combination identification information or the second combination identification information.

After receiving the target combination identification information sent by the electronic device, the first Bluetooth devices may update their own combination identification information from the first combination identification information to this target combination identification information. After receiving the target combination identification information sent by the electronic device, the second Bluetooth devices may update their own combination identification information from the second combination identification information to this target combination identification information.

In some embodiments, after receiving the target combination identification information sent by the electronic device, the first Bluetooth device may check whether the first combination identification information is the same as the target combination identification information. If they are not the same, the first Bluetooth device may update the first combination identification information to this target combination identification information. If they are the same, the first Bluetooth device may not update its own combination identification information. Similarly, after receiving the target combination identification information sent by the electronic device, the second Bluetooth device may check whether the second combination identification information is the same as the target combination identification information. If they are not the same, the second Bluetooth device may update the second combination identification information to this target combination identification information. If they are the same, the second Bluetooth device may not update its own combination identification information.

After the N first Bluetooth devices and the M second Bluetooth devices update their own combination identification information to the target combination identification information, they now match with the same target combination identification information. If an external terminal device simultaneously scans both the first Bluetooth device and the second Bluetooth device, since the combination identification information of the first Bluetooth device and the second Bluetooth device is the same (both being the above-mentioned target combination identification information), the first Bluetooth device and the second Bluetooth device may perform collaborative usage as a single Bluetooth device set.

In some embodiments, the Bluetooth low energy audio (BLE Audio) technology, as a mainstream technology strongly promoted by the Bluetooth SIG in recent years, offers people wireless audio services with a lower power consumption, a reduced cost, a higher quality, and a lower latency. The BLE Audio technology provides a coordinated set identification profile (CSIP), which enables a plurality of Bluetooth devices belonging to the same Bluetooth device set to coordinate and synchronize when interacting with external devices. In the CSIP, the plurality of Bluetooth devices belonging to the same Bluetooth device set may use the same set identity resolving key (SIRK), i.e., the Bluetooth devices with the same SIRK are recognized as being part of the same Bluetooth device set.

In some embodiments of the present disclosure, the target combination identification information may include a target SIRK. The first combination identification information may include a first SIRK. the second combination identification information may include a second SIRK. After receiving the target SIRK sent by the electronic device, the first Bluetooth devices may update their own SIRK from the first SIRK to the target SIRK. After receiving the target SIRK sent by the electronic device, the second Bluetooth devices may update their own SIRK from the second SIRK to the target SIRK. Since the first Bluetooth device and the second Bluetooth device are all configured with the same target SIRK, the first Bluetooth devices and the second Bluetooth devices may successfully join the same target Bluetooth device set. When the various Bluetooth devices perform interaction with the external terminal device, since the various Bluetooth devices are configured with the same target SIRK, the external terminal device is able to use the various Bluetooth devices of the target Bluetooth device set in a coordinated and synchronized manner.

In some embodiments, the target set information, in addition to including the target combination identification information, may further include information such as a number parameter (Size) and/or a serial number (Rank). This number parameter is configured to indicate the number of the Bluetooth devices included in the target Bluetooth device set. In some embodiments of the present disclosure, this number parameter may be the sum of N and M. In other words, this number parameter is a total number of the first Bluetooth devices and the second Bluetooth devices. In some embodiments, this number parameter may be a preset value. For example, if two pairs of earphones are preset to form the same Bluetooth device set for use, the corresponding number parameter may be set as 4. In some embodiments, if two groups of Bluetooth speaker are preset to form the same Bluetooth device set for use, one group includes 2 Bluetooth speakers and another includes 4 Bluetooth speakers, then the corresponding number parameter may be set as 6.

As another implementation embodiment, the user may also set the number parameter for the target Bluetooth device set in accordance with actual needs. In some embodiments, different operation approaches of the setting operation matching with different number parameters may be set in advance. When the electronic device detects a setting operation, the electronic device may determine the corresponding number parameter according to the operation approach of the setting operation, and set the number parameter of the target Bluetooth device set to the number parameter matching with the operation approach of this setting operation. For example, but without limitation, the electronic device may be an earphone case, the earphone case may be provided with a trigger key. When the user clicks the trigger key once, it indicates that the number parameter should be set as 2. When the user clicks the trigger key twice, it indicates that the number parameter should be set as 4, and so on. The earphone case may determine the corresponding number parameter according to the number of times the trigger key is clicked, and set the number parameter matching with the target Bluetooth device set to this matched number parameter.

In some embodiments, the electronic device may be provided with a setting interface. The user may input the number parameter in this setting interface. The electronic device may determine the number parameter input by the user based on the setting operation performed by the user. In some embodiments, the setting interface may also be provided on the terminal device. The electronic device is in communicating connection with the terminal device. The user may input the number parameter in this setting interface. The terminal device determines the number parameter input by the user according to the setting operation performed by the user, and sends this number parameter to the electronic device. In some embodiments, the terminal device may be in communicating connection with any first Bluetooth device or any second Bluetooth device. The terminal device determines the number parameter set by the user according to the setting operation performed by the user, and sends this number parameter to the first Bluetooth device or to the second Bluetooth device that is in communicating connection with the terminal device. When this first Bluetooth device or this second Bluetooth device establishes the communicating connection with the electronic device, this first Bluetooth device or this second Bluetooth device then sends the number parameter to the electronic device for storage.

The serial number is configured to indicate the arrangement order for the Bluetooth device in the target Bluetooth device set. In the same Bluetooth device set, different Bluetooth devices may have different serial numbers. In some embodiments, when the electronic device sends the target set information to the first Bluetooth device or to the second Bluetooth device, the electronic device may either randomly assign the serial numbers, or the electronic device may assign, based on the order in which the communicating connections with the electronic device are established, the serial numbers sequentially in an ascending order. For example, if the electronic device firstly establishes communicating connections with the N first Bluetooth devices, the electronic device may send a serial number 1 to a Bluetooth device that firstly establishes the communicating connection, and a serial number 2 to a Bluetooth device of the first Bluetooth devices that secondly establishes the communicating connection, and so on.

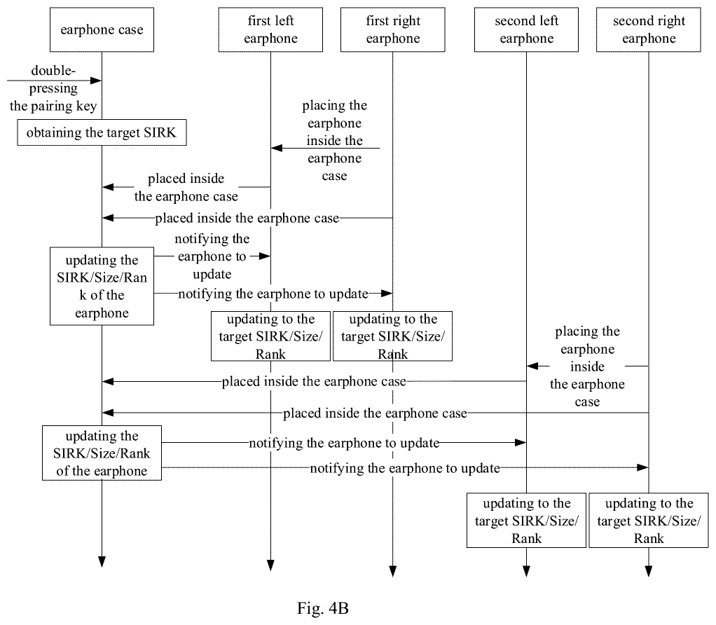

As an example, FIG. 4A is a schematic timing diagram of the information updating method according to another embodiment of the present disclosure. As illustrated in FIG. 4A, the electronic device may obtain the target combination identification information in a case of the first triggering operation. The electronic device may establish the communicating connection with the N first Bluetooth devices, and update the set information (such as the combination identification information, the number parameter, the serial number etc.) configured in the N first Bluetooth devices. The electronic device may send an updating instruction to the various first Bluetooth devices respectively. This updating instruction may carry the target set information, such as the target combination identification information, the number parameter of the target Bluetooth device set, the serial number for the first Bluetooth device in the target Bluetooth device set etc. After receiving the target set information sent by the electronic device, the first Bluetooth devices may update the configured set information according to this target set information. The first combination identification information may be updated to this target combination identification information. The number parameter (i.e., N) of the first Bluetooth device set may be updated to the number parameter of this target Bluetooth device set. The serial number in the first Bluetooth device set may be updated to the serial number in the target Bluetooth device set.

The electronic device may establish the communicating connection with the M second Bluetooth devices, and update the set information (such as the combination identification information, the number parameter, the serial number etc.) configured in the M second Bluetooth devices. The electronic device may send the updating instruction to the various second Bluetooth devices respectively. This updating instruction may carry the target set information, such as the target combination identification information, the number parameter of the target Bluetooth device set, the serial number for the second Bluetooth device in the target Bluetooth device set etc. After receiving the target set information sent by the electronic device, the second Bluetooth devices may update the configured set information according to this target set information. The second combination identification information may be updated to this target combination identification information. The number parameter (i.e., M) of the second Bluetooth device set may be updated to the number parameter of this target Bluetooth device set. The serial number in the second Bluetooth device set may be updated to the serial number in the target Bluetooth device set.

As an example, FIG. 4B is a schematic timing diagram of the information updating method according to yet another embodiment of the present disclosure. Taking a case as an example, where the electronic device includes an earphone case, each of the N first Bluetooth devices includes a first left earphone and a first right earphone, and each of the M second Bluetooth devices includes a second left earphone and a second right earphone. As illustrated in FIG. 4B, the user may perform the first triggering operation (for example, touch-controlling a paring key on the earphone case) on the earphone case. In case of the first triggering operation, the earphone case may obtain the target SIRK. The user may place the first left earphone and the first right earphone inside the earphone case respectively. In a case where the first left earphone and the first right earphone are placed inside the earphone case, the earphone case may send the target set information to the first left earphone and to the first right earphone respectively. The earphone case may update the parameters (such as the SIRK, the Size (i.e., the number parameter), the Rank (i.e., the serial number), etc.) configured for the first left earphone and for the first right earphone respectively. The earphone case may send the updating instruction to the first left earphone, to notify the first left earphone to update parameters such as the SIRK, the Size, the Rank, etc. The earphone case may send the updating instruction to the first right earphones, to notify the first right earphone to update parameters such as the SIRK, the Size, the Rank, etc. After receiving parameters such as the target SIRK, the Size (e.g., 4) of the target Bluetooth device set, and the Rank (e.g., 1) of the first left earphone in the target Bluetooth device set sent by the earphone case, the first left earphone may update its own SIRK from the first SIRK to the target SIRK, update the Size (e.g., 2) of the first Bluetooth device set to the Size of the target Bluetooth device set, and update its own Rank in the first Bluetooth device set to the Rank in the target Bluetooth device set. After receiving parameters such as the target SIRK, the Size (e.g., 4) of the target Bluetooth device set, and the Rank (e.g., 2) of the first right earphone in the target Bluetooth device set sent by the earphone case, the first right earphone may update its own SIRK from the first SIRK to the target SIRK, update the Size (e.g., 2) of the first Bluetooth device set to the Size of the target Bluetooth device set, and update its own Rank in the first Bluetooth device set to the Rank in the target Bluetooth device set.

The user may remove the first left earphone and the first right earphone from the earphone case, and then place the second left earphone and the second right earphone into the earphone case respectively. In a case where the second left earphone and the second right earphone are placed inside the earphone case, the earphone case may send the target set information to the second left earphone and to the second right earphone respectively. The earphone case may update the parameter (such as the SIRK, the Size, the Rank, etc.) configured for the second left earphone and for the second right earphone respectively. The earphone case may send the updating instruction to the second left earphone, to notify the second left earphone to update parameters such as the SIRK, the Size, the Rank, etc. The earphone case may send the updating instruction to the second right earphones, to notify the second right earphones to update parameters such as the SIRK, the Size, the Rank, etc. After receiving parameters such as the target SIRK, the Size (e.g., 4) of the target Bluetooth device set, and the Rank (e.g., 3) of the second left earphone in the target Bluetooth device set sent by the earphone case, the second left earphone may update its own SIRK from the second SIRK to the target SIRK, update the Size (e.g., 2) of the second Bluetooth device set to the Size of the target Bluetooth device set, and update its own Rank in the second Bluetooth device set to the Rank in the target Bluetooth device set. After receiving parameters such as the target SIRK, the Size (e.g., 4) of the target Bluetooth device set, and the Rank (e.g., 4) of the second right earphone in the target Bluetooth device set sent by the earphone case, the second right earphone may update its own SIRK from the second SIRK to the target SIRK, update the Size (e.g., 2) of the second Bluetooth device set to the Size of the target Bluetooth device set, and update its own Rank in the second Bluetooth device set to the Rank in the target Bluetooth device set.

In some embodiments of the present disclosure, the electronic device sends the target set information to the N first Bluetooth devices of the first Bluetooth device set, enabling the first Bluetooth device to update the first set information to the target set information. The electronic device sends the target set information to the M second Bluetooth devices of the second Bluetooth device set, enabling the second Bluetooth device to update the second set information to the target set information. The target set information is configured to indicate the target Bluetooth device set. The N first Bluetooth devices originally belonging to the first Bluetooth device set and the M second Bluetooth devices originally belonging to the second Bluetooth device set may be successfully configured to be belonging to the target Bluetooth device set for collaborative use. The Bluetooth devices from different Bluetooth device set may be dynamically and flexibly grouped into a same Bluetooth device set for collaborative use, thereby meeting the user's use requirements.

In some embodiments, the target set information includes the target combination identification information. The following will introduce several approaches for the electronic device to obtain the target combination identification information. The approaches for the electronic device to obtain the target combination identification information may include, but be not limited to, any of the following obtaining approaches.

A first obtaining approach: generating the target combination identification information according to a preset approach.

The operation in which the electronic device generates the target combination identification information according to the preset approach may include: generating the target combination identification information based on a target BLE address, wherein the target BLE address includes an BLE address of any of the first Bluetooth devices or an BLE address of any of the second Bluetooth devices; or, randomly generating combination identification information as the target combination identification information.

The electronic device may obtain the target BLE address, and generate, according to a particular approach and based on the target BLE address, the target combination identification information. In some embodiments, this particular approach may be directly using the target BLE address as part of the fields of the target combination identification information to generate the target combination identification information. Further, the target BLE address may be taken as part of the fields of the target combination identification information, and this part of the fields may be combined with a first preset field, and generate the target combination identification information. This first preset field may refer to predefined field information in the combination identification information, or may refer to randomly generated field information. For example, the target combination identification information may include the target SIRK. The SIRK may include 128 bytes. The BLE address (48 bytes) may be directly used as part of the fields of the target SIRK. For example, SIRK=BLE address∥the first preset field.

In some embodiments, this particular approach may also be performing a hash calculation on the target BLE address, and taking a calculation result as part of the fields of the target combination identification information to generate the target combination identification information. Furthermore, the calculation result may be combined with a second preset field to generate the target combination identification information. For example, SIRK=HASH∥the second preset field. Here, this HASH represents the calculation result of performing a hash calculation on the target BLE address. The first preset field and the second preset field may be the same or different, and may be set according to actual situations respectively. Since the BLE address is unique, it may ensure that the generated target combination identification information is also unique, and would not be confused with the combination identification information of other Bluetooth device sets, thereby enhancing the accuracy of the usage of the Bluetooth device set.

As a specific implementation embodiment, an obtaining rule of the target BLE address may be set in accordance with actual needs. In some embodiments, in a case where the electronic device firstly establishes the communicating connection with the N first Bluetooth devices, the target BLE address may be the BLE address of any of the first Bluetooth devices, the target BLE address may also be the BLE address of a Bluetooth device of the first Bluetooth devices that firstly establishes the communicating connection with the electronic device, or the BLE address may be the last one of the first Bluetooth devices that establishes the communicating connection with the electronic device, and so on. In some embodiments, in a case where the electronic device firstly establishes the communicating connection with the M second Bluetooth devices, the target BLE address may be the BLE address of any of the second Bluetooth devices, the target BLE address may also be the BLE address of a Bluetooth device of the second Bluetooth devices that firstly establishes the communicating connection with the electronic device, or the BLE address may be the last one of the second Bluetooth devices to establish the communicating connection with the electronic device, and so on. The electronic device obtains the target BLE address according to preset obtaining rules, ensuring that the target combination identification information is generated in a timely manner, and is sent to the N first Bluetooth devices and the M second Bluetooth devices, thereby improving efficiency.

In some embodiments, the electronic device may also randomly generate combination identification information as the target combination identification information. The electronic device may store the various fields of the target combination identification information in advance, and randomly generate the field values for the various fields, so as to obtain unique target combination identification information. In this way, the accuracy of the usage of the Bluetooth device set is enhanced. The electronic device may also adopt other kinds of approaches to generate the target combination identification information, which are not limited to the above-mentioned several approaches.

In some embodiments of the present disclosure, the electronic device may generate the target combination identification information according to a preset approach, and may ensure that the generated target combination identification information is unique, thereby avoiding a case of confusion with other Bluetooth device sets. In this way, it is ensured that, the N first Bluetooth devices and the M second Bluetooth devices all successfully join the target Bluetooth device set, thereby meeting the user's usage requirements.

A second obtaining approach: taking the combination identification information stored in the electronic device as the target combination identification information.

The electronic device may store the target combination identification information in advance, or the electronic device may pre-store the target combination identification information. In a case where the communicating connection is established between the electronic device and the N first Bluetooth devices, the target combination identification information that is stored in advance may be sent to the N first Bluetooth devices. After receiving the target combination identification information sent by the electronic device, the first Bluetooth devices may check whether their own combination identification information (i.e., the first combination identification information) is the same as this target combination identification information. If they are not the same, the first Bluetooth devices may update their own combination identification information to this target combination identification information. If they are the same, the first Bluetooth device may not perform update of their own combination identification information.

As a specific implementation embodiment, the combination identification information includes the SIRK. For example, if the SIRK stored in the electronic device is an SIRK3, this SIRK3 may be sent as the target SIRK to the N first Bluetooth devices. If the first SIRK currently configured for the first Bluetooth devices is an SIRK1, after receiving the target SIRK sent by the electronic device, since the target SIRK is different from the first SIRK, the first Bluetooth devices may update the first SIRK to the target SIRK. In other words, the first Bluetooth device will update their own SIRK from the SIRK1 to the SIRK3. For a further example, if the SIRK stored in the electronic device is the SIRK1, this SIRK1 may be sent as the target SIRK to the N first Bluetooth devices. If the first SIRK currently configured for the first Bluetooth devices is also the SIRK1, after receiving the target SIRK sent by the electronic device, since the target SIRK is the same as the first SIRK (both are the SIRK1), the first Bluetooth devices may not update their first SIRK.

In a case where the communicating connection is established between the electronic device and the M second Bluetooth devices, the target combination identification information that is stored in advance may be sent to the M second Bluetooth devices. After receiving the target combination identification information sent by the electronic device, the second Bluetooth device may check whether their own combination identification information (i.e., the second combination identification information) is the same as this target combination identification information. If they are not the same, the second Bluetooth device may update their own combination identification information to this target combination identification information. If they are the same, the second Bluetooth devices may not perform update of their own combination identification information.

In some embodiments of the present disclosure, the electronic device may send the pre-stored combination identification information as the target combination identification information to the N first Bluetooth devices and to the M second Bluetooth devices, respectively. Thus, the N first Bluetooth devices originally belonging to the first Bluetooth device set and the M second Bluetooth devices originally belonging to the second Bluetooth device set may all be successfully configured to be belonging to the target Bluetooth device set for collaborative use. In this way, the user's usage requirements are met.

A third obtaining approach: obtaining the combination identification information that is currently configured for a target Bluetooth device as the target combination identification information, wherein the target Bluetooth device is any of the first Bluetooth devices or any of the second Bluetooth devices.

The electronic device may select any first Bluetooth device or any second Bluetooth device in communicating connection with the electronic device as the target Bluetooth device, and obtain, from this target Bluetooth device, the combination identification information that is currently configured for the target Bluetooth device. In some embodiments, if the electronic device selects any first Bluetooth device in communicating connection with the electronic device as the target Bluetooth device, then after obtaining, from this target Bluetooth device, the combination identification information that is currently configured for the target Bluetooth device as the target combination identification information, the electronic device may not send this target combination identification information to the N first Bluetooth devices, but the electronic device may only send the target combination identification information to the M second Bluetooth devices. Similarly, if the electronic device selects any second Bluetooth device in communicating connection with the electronic device as the target Bluetooth device, then after obtaining, from this target Bluetooth device, the combination identification information that is currently configured for the target Bluetooth device as the target combination identification information, the electronic device may not send this target combination identification information to the M second Bluetooth devices, but the electronic device may only send the target combination identification information to the N first Bluetooth devices. The information updating efficiency of the Bluetooth devices may be enhanced.

Further, the combination identification information includes the SIRK. For example, the electronic device selects any first Bluetooth device as the target Bluetooth device. If the SIRK currently configured for the first Bluetooth device is the SIRK1 (i.e., the first SIRK), the electronic device may obtain the SIRK1 from this first Bluetooth device, and take this SIRK1 as the target SIRK. The electronic device may then send this target SIRK to the second Bluetooth devices, thereby allowing the second Bluetooth devices to update their own SIRK to this target SIRK (i.e., the SIRK1). After the second Bluetooth devices complete the updating of the SIRK, the N first Bluetooth devices and the M second Bluetooth devices would all be configured with the same SIRK (all are the SIRK1), thus the N first Bluetooth devices and the M second Bluetooth devices may all be recognized as belonging to the same Bluetooth device set for collaborative use.

As a specific implementation embodiment, the above-mentioned target Bluetooth device may be a Bluetooth device from both the first Bluetooth device set and the second Bluetooth device set, that firstly establishes the communicating connection with the electronic device. For example, the electronic device firstly establishes the communicating connection with the N first Bluetooth devices, the target Bluetooth device may be any of the first Bluetooth devices. Further, this target Bluetooth device may be a Bluetooth device of the first Bluetooth devices that firstly establishes the communicating connection with the electronic device. Therefore, it may be ensured that, the electronic device may timely obtain the target combination identification information. This ensures the successful rate and efficiency of a process, in which the N first Bluetooth devices originally belonging to the first Bluetooth device set and the M second Bluetooth devices originally belonging to the second Bluetooth device set all being configured to be belonging to the target Bluetooth device set for collaborative use.

In some embodiments of the present disclosure, the electronic device may obtain the combination identification information currently configured for the target Bluetooth device as the target combination identification information, and send the same to the N first Bluetooth devices and to the M second Bluetooth devices. This target Bluetooth device is any of the first Bluetooth devices or any of the second Bluetooth devices, such that the first Bluetooth device and the second Bluetooth device are configured with the same target combination identification information, the N first Bluetooth devices originally belonging to the first Bluetooth device set and the M second Bluetooth devices originally belonging to the second Bluetooth device set may all be successfully configured to be belonging to the target Bluetooth device set for collaborative use.

In the above-mentioned various embodiments, the combination identification information, in addition to the SIRK, may also include other combination identification information. For example, if the Bluetooth devices within the same Bluetooth device set collectively use the same Bluetooth address to establish the Bluetooth communicating connection with an external device, the combination identification information may include, without limitation, the Bluetooth address, and the like.

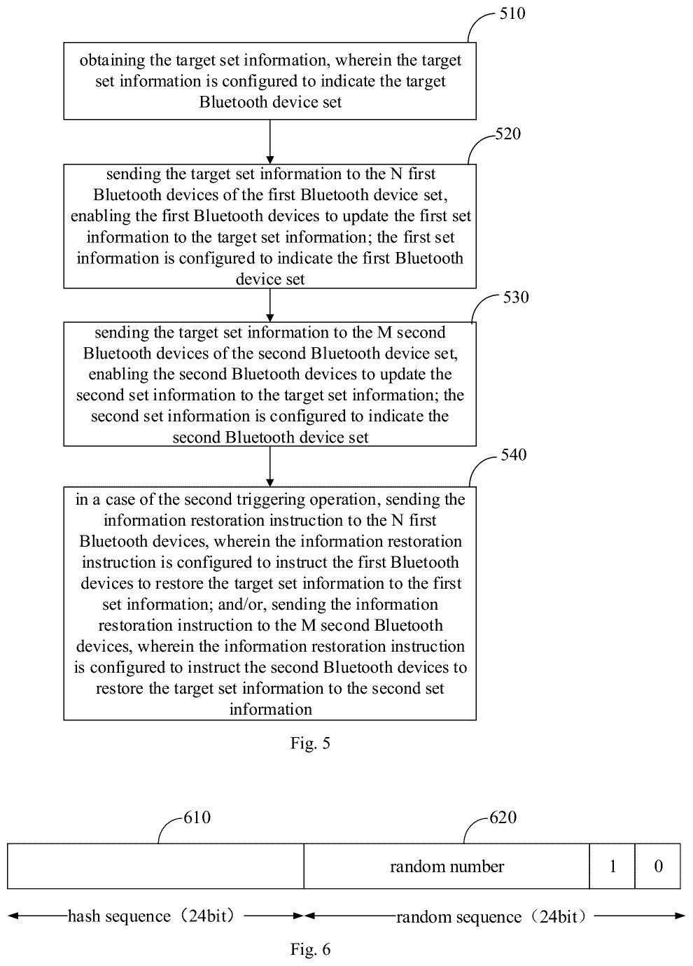

As illustrated in FIG. 5, in some embodiments, the information updating method that may be performed by or applied to the above-mentioned electronic device is provided. The method may include the following operations at blocks as illustrated in FIG. 5.

The operation at block 510: obtaining the target set information, wherein the target set information is configured to indicate the target Bluetooth device set.

The operation at block 520: sending the target set information to the N first Bluetooth devices of the first Bluetooth device set, enabling the first Bluetooth devices to update the first set information to the target set information. The first set information is configured to indicate the first Bluetooth device set.

The operation at block 530: sending the target set information to the M second Bluetooth devices of the second Bluetooth device set, enabling the second Bluetooth devices to update the second set information to the target set information. The second set information is configured to indicate the second Bluetooth device set.

The description of the operations at blocks 510-530 may refer to the related description in the above-mentioned various embodiments, and will not be elaborated herein.

In some embodiments, after the N first Bluetooth devices update the first set information to the target set information, and the M second Bluetooth devices update the second set information to the target set information, the N first Bluetooth devices may establish the LE Audio Bluetooth connection with the terminal device based on the target set information, and the M second Bluetooth devices may establish the LE Audio Bluetooth connection with the terminal device based on the target set information. The sharing of the audio transmitted by the terminal device between the N first Bluetooth devices and the M second Bluetooth devices is achieved.

The first Bluetooth device may send, based on the target set information, the LE Audio broadcasting signal, so as to trigger the terminal device to establish the LE Audio Bluetooth connection with the first Bluetooth device. The second Bluetooth device may also send, based on the target set information, the LE Audio broadcasting signal, so as to trigger the terminal device to establish the LE Audio Bluetooth connection with the second Bluetooth device.

In some embodiments, when the terminal device receives the LE Audio broadcasting signal sent by a Bluetooth device in the target Bluetooth device set for the first time, the terminal device may display, on a Bluetooth connection interface, device information (information such as the BLE address, a device name, etc.) matching with the Bluetooth device. After the user confirms to allow the terminal device to establish the Bluetooth connection with this Bluetooth device, the terminal device may establish the LE Audio Bluetooth connection with this Bluetooth device in case of a connection operation, and obtain the target set information matching with this Bluetooth device. In some embodiments, during the process of establishing the LE Audio Bluetooth connection with the Bluetooth device, the terminal device may receive the target set information sent by this Bluetooth device.

In some embodiments, the target set information includes the target combination identification information. The various Bluetooth devices belonging to the target Bluetooth device set may send the LE Audio broadcasting signal based on the same target combination identification information. After the terminal device initially establishes the LE Audio Bluetooth connection with a Bluetooth device in the target Bluetooth device set, if the terminal device receives the LE Audio broadcasting signal sent by another Bluetooth device once again, the terminal device may check, based on the LE Audio broadcasting signal sent by the another Bluetooth device, whether the combination identification information matching with the another Bluetooth device is the same as that matching with the initially connected Bluetooth device. If they are the same, the terminal device may determine that, the another Bluetooth device and the initially connected Bluetooth device belong to the same Bluetooth device set. The terminal device may then automatically send a Bluetooth connection request to the another Bluetooth device to establish the LE Audio Bluetooth connection with this another Bluetooth device.

As a specific implementation embodiment, the various Bluetooth devices belonging to the target Bluetooth device set may send the LE Audio broadcasting signal based on the same target SIRK. When the terminal device receives the LE Audio broadcasting signal sent by a Bluetooth device in the target Bluetooth device set for the first time, the terminal device may establish the LE Audio Bluetooth connection with this Bluetooth device, and obtain the SIRK (i.e., the target SIRK) matching with this Bluetooth device. As an implementation embodiment, during the process of establishing the LE Audio Bluetooth connection with this Bluetooth device, the terminal device may receive the SIRK sent by this Bluetooth device. The LE Audio Bluetooth connection is established on the basis of the BLE connection. The process of establishing the LE Audio Bluetooth connection may include querying some device parameters on the basis of the BLE connection. The operation of querying the device parameter may include querying the SIRK of the Bluetooth device. After the LE Audio Bluetooth connection is established, in case of a service requirement, a connected isochronous streams (CIS) channel or the like may be established for service data transmission.

If the terminal device receives the LE Audio broadcasting signal sent by another Bluetooth device, the terminal device may determine, according to the LE Audio broadcasting signal sent by the another Bluetooth device, whether the SIRK matching with the another Bluetooth device is the same as the target SIRK. If they are the same, the terminal device may then automatically send the Bluetooth connection request to the another Bluetooth device to establish the LE Audio Bluetooth connection with the another Bluetooth device.

As an implementation embodiment, the LE Audio broadcasting signal sent by the Bluetooth device may include a target field generated by calculating based on the target SIRK. After receiving the LE Audio broadcasting signal sent by the another Bluetooth device, the terminal device may parse the LE Audio broadcasting signal sent by the another Bluetooth device, and obtain a target-specific broadcasting information and the target field carried by this LE Audio broadcasting signal. A target local value may be calculated based on the SIRK (i.e., the target SIRK) matching with the initially connected Bluetooth device and on the target-specific broadcasting information. If the target local value is the same as the target field, it may be determined that, the initially connected Bluetooth device and the another Bluetooth device belong to the same Bluetooth device set.

In some embodiments, as illustrated in FIG. 6, the LE Audio broadcasting signal may include resolvable set identifier (RSI). The RSI may include two parts, namely a part 1 and a part 2. The part 1 is a hash sequence 610 generated by the SIRK for the Bluetooth device. The part 2 is a random sequence 620 generated by a random number. The hash sequence 610 may be calculated by adopting the formula: hash=sih(SIKR, prand). Here, the hash represents the hash sequence 610, and the prand represents the random sequence 620. The target-specific broadcasting information obtained by the electronic device through parsing the LE Audio broadcasting signal sent by the another Bluetooth device may be the random sequence of the RSI. The target field may be the hash sequence of the RSI carried by the LE Audio broadcasting signal. The electronic device may calculate, according to the SIRK (i.e., the target SIRK) matching with the initially connected Bluetooth device and to the random sequence of the RSI obtained through parsing, the target local value through the above-mentioned formula. The target local value is then compared with the hash sequence of the RSI obtained through parsing. If the target local value is the same as the hash sequence, it is indicated that, the SIRK of the initially connected Bluetooth device is the same as the SIRK of the another Bluetooth device (both are the target SIRK). In this case, it may be determined that, the initially connected Bluetooth device and the another Bluetooth device belong to the same Bluetooth device set.

In some embodiments, after determining that the combination identification information matching with the another Bluetooth device is the same as the combination identification information matching with the initially connected Bluetooth device, the terminal device may check whether the number of the currently connected Bluetooth devices belonging to the target Bluetooth device set has reached the number parameter. If the number parameter has been reached, the terminal device will not establish the LE Audio Bluetooth connection with the another Bluetooth device. For example, when the terminal device establishes the LE Audio Bluetooth connection with the Bluetooth device in the target Bluetooth device set for the first time, the terminal device obtains that, the number parameter of the target Bluetooth device set is 4. In a case where the terminal device has already established the LE Audio Bluetooth connections with 4 Bluetooth devices in the target Bluetooth device set, and receives the LE Audio broadcasting signal from the another Bluetooth device, and the combination identification information matching with the another Bluetooth device is also the target combination identification information, thus the terminal device will not establish the LE Audio Bluetooth connection with the another Bluetooth device. In this way, the accuracy of the Bluetooth connections may be guaranteed, and the accuracy of the audio sharing process in subsequent operations may also be guaranteed.

In some embodiments, after determining that the combination identification information matching with the another Bluetooth device is the same as the combination identification information matching with the initially connected Bluetooth device, the terminal device may determine whether the serial number for the another Bluetooth device in the target Bluetooth device set conflicts with the serial number for the currently connected Bluetooth devices that belong to the target Bluetooth device set. If there is a conflict, the terminal device may not establish the LE Audio Bluetooth connection with the another Bluetooth device. For example, when the terminal device establishes the LE Audio Bluetooth connection with the Bluetooth device in the target Bluetooth device set for the first time, the terminal device obtains that, the serial number matching with this initially connected Bluetooth device is 1. If the terminal device receives the LE Audio broadcasting signal sent by the another Bluetooth device, the combination identification information matching with this another Bluetooth device is also the target combination identification information, and the serial number matching with the another Bluetooth device is also 1, which conflicts with the serial number for the initially connected Bluetooth device. This indicates a connection error, and the terminal device would not establish the LE Audio Bluetooth connection with the another Bluetooth device. In this way, the accuracy of the Bluetooth connections may be guaranteed, and the accuracy of the audio sharing process in subsequent operations may also be guaranteed.

As another implementation embodiment, after determining that the combination identification information matching with the another Bluetooth device is the same as the combination identification information matching with the initially connected Bluetooth device, the terminal device may also establish the LE Audio Bluetooth connection with the another Bluetooth device first. The terminal device may then check whether the number of the currently connected Bluetooth devices that belong to the target Bluetooth device set has exceeded the number parameter, and determine whether the serial number matching with the another Bluetooth device in the target Bluetooth device set conflicts with the serial numbers of other Bluetooth devices that belong to the target Bluetooth device set and are connected to the terminal device. If the number of the currently connected Bluetooth devices belonging to the target Bluetooth device set has exceeded the number parameter, and/or, the serial number matching with the another Bluetooth device conflicts with the serial numbers matching with other Bluetooth devices that are connected to the terminal device, the terminal device may then disconnect from the LE Audio Bluetooth connection with the another Bluetooth device.

The process of the terminal device establishing the LE Audio Bluetooth connections with each of the various Bluetooth devices of the target Bluetooth device set (including the N first Bluetooth devices and the M second Bluetooth devices) respectively may all follow the processes described in the above-mentioned embodiments.

After the terminal device establishes the LE Audio Bluetooth connections with the N first Bluetooth devices and with the M second Bluetooth devices respectively, the terminal device may send the audio data to the N first Bluetooth devices and to the M second Bluetooth devices respectively, so that all of the N first Bluetooth devices and the M second Bluetooth devices may share the audio data sent by the terminal device.

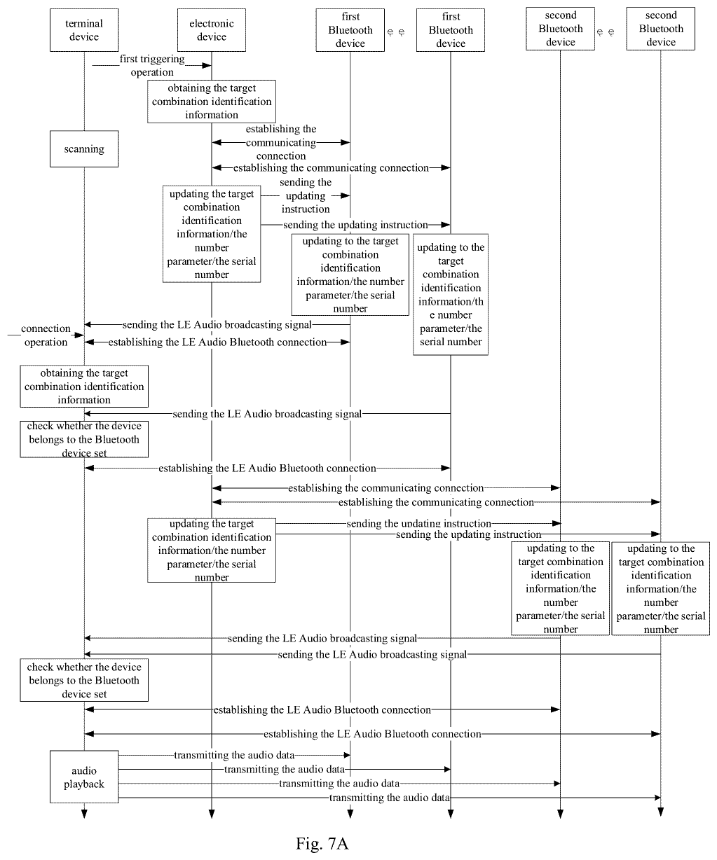

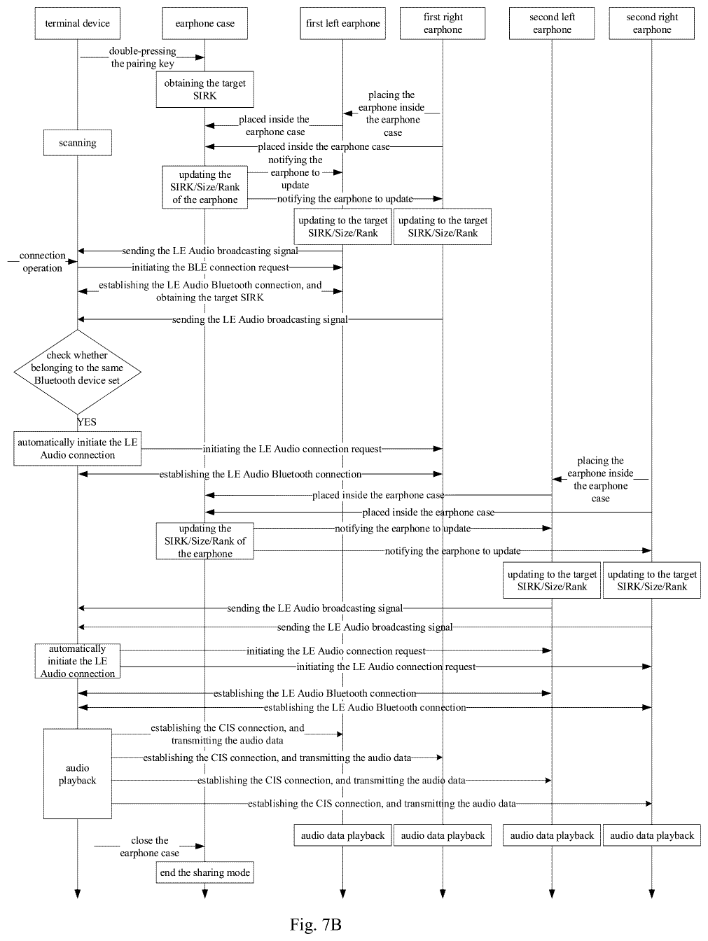

As an example, FIG. 7A is a schematic timing diagram illustrating that N first Bluetooth devices and M second Bluetooth devices sharing audio data transmitted by the terminal device according to an embodiment of the present disclosure. As illustrated in FIG. 7A, after the first Bluetooth devices updates, according to the updating instruction sent by the electronic device, the target set information such as the target combination identification information, the number parameter, and the serial number etc., the first Bluetooth devices may send the LE Audio broadcasting signal. The terminal device may activate a scanning mode. In a case where the LE Audio broadcasting signal sent by the first one of the first Bluetooth devices is scanned for the first time, the terminal device may display the device information matching with this first one of the first Bluetooth devices. The user may then determine whether to allow the terminal device to establish the Bluetooth connection with this one of the first Bluetooth devices. If the terminal device detects a connection operation, the terminal device may establish the LE Audio Bluetooth connection with the first one of the first Bluetooth devices in response to this connection operation, and obtain the target combination identification information matching with the first one of the first Bluetooth devices. In a case where the LE Audio broadcasting signal sent by the X-th one of the first Bluetooth devices is scanned, the terminal device may check whether the X-th one of the first Bluetooth devices belongs to the same Bluetooth device set as the first one of the first Bluetooth devices. If it is determined that, the X-th one of the first Bluetooth devices and the first one of the first Bluetooth devices both belong to the same Bluetooth device set (both belong to the target Bluetooth device set), the terminal device may establish the LE Audio Bluetooth connection with the X-th one of the first Bluetooth devices. Here, X may be an integer greater than 1 and less than or equal to N.

After the second Bluetooth devices updates, according to the updating instruction sent by the electronic device, the target set information such as the target combination identification information, the number parameter, and the serial number etc., the first Bluetooth device may send the LE Audio broadcasting signal. In a case where the LE Audio broadcasting signal sent by the Y-th one of the second Bluetooth devices is scanned, the terminal device may check whether the Y-th one of the second Bluetooth devices belongs to the same Bluetooth device set as the first one of the first Bluetooth devices. If it is determined that, the Y-th one of the second Bluetooth devices and the first one of the first Bluetooth devices both belong to the same Bluetooth device set (both belong to the target Bluetooth device set), the terminal device may establish the LE Audio Bluetooth connection with the Y-th one of the second Bluetooth devices. Here, X may be an integer greater than 0 and less than or equal to M.

After the terminal device establishes the LE Audio Bluetooth connections with the N first Bluetooth devices and with the M second Bluetooth devices respectively, the terminal device may send audio data to the N first Bluetooth devices and to the M second Bluetooth devices respectively, so that all of the N first Bluetooth devices and the M second Bluetooth devices may share the audio data sent by the terminal device.

In some embodiments of the present disclosure, the terminal device may establish the LE Audio Bluetooth connections with all the N first Bluetooth devices and all the M second Bluetooth devices that have updated their target set information respectively, and send the audio data to all the N first Bluetooth devices and to all the M second Bluetooth devices. In this way, the audio sharing between the N first Bluetooth devices and the M second Bluetooth devices is achieved, the reliability of the audio data transmission may be enhanced.

The operation at block 540: in a case of a second triggering operation, sending an information restoration instruction to the N first Bluetooth devices, wherein the information restoration instruction is configured to instruct the first Bluetooth devices to restore the target set information to the first set information; and/or, sending the information restoration instruction to the M second Bluetooth devices, wherein the information restoration instruction is configured to instruct the second Bluetooth devices to restore the target set information to the second set information.

In some embodiments, the user may perform the second triggering operation on the electronic device, so as to trigger the electronic device to restore the N first Bluetooth devices and the M second Bluetooth devices in the target Bluetooth device set to their independent or separate usage function, thereby allowing the N first Bluetooth devices and the M second Bluetooth devices to be restored to a state, where the Bluetooth device set to which the N first Bluetooth devices belong is different from the Bluetooth device set to which the M second Bluetooth devices belong. In other words, the N first Bluetooth devices belong to the first Bluetooth device set, and the M second Bluetooth devices belong to the second Bluetooth device set, and the N first Bluetooth devices and the M second Bluetooth devices would no longer be used in a collaborative approach.

The specific operation approach of this second triggering operation is not restricted in some embodiments of the present disclosure. For example, the electronic device may be provided with a particular key. This particular key may be either a virtual key or a physical key. The second triggering operation may be a preset operation on the particular key, such as, pressing-and-holding for a period of time, clicking the particular key, double-clicking the particular key etc. For another example, the second triggering operation may be any of a touch operation, a gesture operation, a voice operation etc. The electronic device may, without limitation, detect the second triggering operation through a corresponding sensor. For example, the electronic device may detect a preset press operation through a pressure sensor, detect a preset gesture operation through a proximity sensor, detect a preset voice content through a voice sensor, etc. The second triggering operation may be the same as or be different from the first triggering operation of the above-mentioned embodiments.

As an example, taking a case as an example, where the electronic device is the earphone case, each of the N first Bluetooth devices includes the first left earphone and the first right earphone, each of the M second Bluetooth devices includes the second left earphone and the second right earphone. The second triggering operation may refer to, placing the first left earphone and the first right earphone inside the earphone case, and performing a pressing-and-holding operation on the pairing key of the earphone case. In some embodiments, the second triggering operation may refer to, placing the first left earphone and the first right earphone inside the earphone case, and close the case lid, etc. In a case where the first left earphone and the first right earphone are placed inside the earphone case, the earphone case may send the information restoration instruction to the first left earphone and to the first right earphone respectively, the first left earphone and the first right earphone may restore the target set information to the first set information according to this information restoration instruction. In a case where the second left earphone and the second right earphone are placed inside the earphone case, the earphone case may send the information restoration instruction to the second left earphone and to the second right earphone respectively, the second left earphone and the second right earphone may restore the target set information to the second set information according to the information restoration instruction.

As an example, FIG. 7B is a schematic timing diagram illustrating that N first Bluetooth devices and M second Bluetooth devices sharing audio data transmitted by the terminal device according to another embodiment of the present disclosure. As illustrated in FIG. 7B, taking a case as an example, where the electronic device includes the earphone case, each of the N first Bluetooth devices includes the first left earphone and the first right earphone, and each of the M second Bluetooth devices includes the second left earphone and the second right earphone. After the first left earphone performs updating according to parameters such as the target SIRK sent by the earphone case, the Size of the target Bluetooth device set, and the Rank of the first left earphone in the target Bluetooth device set, the first left earphone may then send the LE Audio broadcasting signal. The terminal device may enable the scanning mode. In a case where the LE Audio broadcasting signal sent by the first left earphone is scanned, the terminal device may display the device information matching with the first left earphone. The user may then determine whether to allow the terminal device to establish the Bluetooth connection with the first left earphone. If the terminal device detects the connection operation, in response to this connection operation, the terminal device may initiate the LE Audio connection request to the first left earphone, establish the LE Audio Bluetooth connection with the first left earphone, and obtain the target SIRK matching with the first left earphone.

After the first right earphone performs updating according to parameters such as the target SIRK sent by the earphone case, the Size of the target Bluetooth device set, and the Rank of the first right earphone in the target Bluetooth device set, the first right earphone may also send the LE Audio broadcasting signal. In a case where the LE Audio broadcasting signal sent by the first right earphone is scanned, the terminal device may check whether the first right earphone belongs to the same Bluetooth device set as the first left earphone. In other words, the terminal device may check whether the first right earphone and the first left earphone both match with the same target SIRK. If it is determined that, the first right earphone and the first left earphone belong to the same Bluetooth device set (both belong to the target Bluetooth device set), the terminal device may automatically initiate the LE Audio connection request to the first right earphone, and establish the LE Audio Bluetooth connection with the first right earphone.

After the second left earphone performs updating according to parameters such as the target SIRK sent by the earphone case, the Size of the target Bluetooth device set, and the Rank of the second left earphone in the target Bluetooth device set, the second left earphone may then send the LE Audio broadcasting signal. In a case where the LE Audio broadcasting signal sent by the second left earphone is scanned, the terminal device may check whether the second left earphone belongs to the same Bluetooth device set as the first left earphone. If it is determined that, the second left earphone and the first left earphone belong to the same Bluetooth device set (both belong to the target Bluetooth device set), the terminal device may automatically initiate the LE Audio connection request to the second left earphone, and establish the LE Audio Bluetooth connection with the second left earphone.

After the second right earphone performs updating according to parameters such as the target SIRK sent by the earphone case, the Size of the target Bluetooth device set, and the Rank of the second right earphone in the target Bluetooth device set, the second right earphone may also send the LE Audio broadcasting signal. In a case where the LE Audio broadcasting signal sent by the second right earphone is scanned, the terminal device may check whether the second right earphone belongs to the same Bluetooth device set as the first left earphone. If it is determined that, this second right earphone and the first left earphone both belong to the same Bluetooth device set (both belong to the target Bluetooth device set), the terminal device may automatically initiate the LE Audio connection request to the second right earphone, and establish the LE Audio Bluetooth connection with the second right earphone.

In this way, the terminal device may establish the LE Audio Bluetooth connection with each of the two pairs of earphones respectively, and may recognize the two pairs of earphones as the same Bluetooth device set, and collaboratively use the two pairs of earphones. When the terminal device plays audio, the terminal device may establish the CIS connection with each of the first left earphone, the first right earphone, the second left earphone, and the second right earphone respectively, and transmit the audio data to the first left earphone, to the first right earphone, to the second left earphone, and to the second right earphone, thereby achieving the audio sharing of the two pairs of earphones. Further, the terminal device may send the left channel audio data to the first left earphone and to the second left earphone respectively, so that both the first left earphone and the second left earphone share the same left channel audio data. The terminal device may also send the right channel audio data to the first right earphone and to the second right earphone respectively, so that the first right earphone and the second right earphone share the same right channel audio data. Each earphone of the two pairs of earphones may maintain its service information unchanged, such that each earphone retains its original audio playback property (e.g., the left earphones support the left channel audio playback, and the right earphones support the right channel audio playback). The terminal device may establish the CIS channel with each earphone of the two pairs of earphones respectively, and transmit the corresponding audio data to each earphone through the established CIS channels, thereby achieving the audio data sharing between the two pairs of earphones. In this audio sharing solution, no additional hardware costs are required, a better compatibility may be provided, thereby further ensuring the reliability of the transmission.

When the user intends to end a sharing mode between the two pairs of earphones, the user may perform the second triggering operation. For example, the user may place the first left earphone and the first right earphone inside the earphone case and close the earphone case, or the user may place the second left earphone and the second right earphone inside the earphone case and close the earphone case. Then the earphone case may send an information restoration instruction to the first left earphone and the first right earphone that are placed inside the earphone case, causing both the first left earphone and the first right earphone that are placed inside the earphone case: to restore the target SIRK to the first SIRK, to restore the Size of the target Bluetooth device set to the Size of the first Bluetooth device set, and to restore the Rank in the target Bluetooth device set to the Rank in the first Bluetooth device set. In some embodiments, the earphone case may send the information restoration instruction to the second left earphone and the second right earphone that are placed inside the earphone case, causing both the second left earphone and the second right earphone that are placed inside the earphone case: to restore the target SIRK to the second SIRK, to restore the Size of the target Bluetooth device set to the Size of the second Bluetooth device set, and to restore the Rank in the target Bluetooth device set to the Rank in the second Bluetooth device set.

In some embodiments of the present disclosure, the N first Bluetooth devices originally belonging to the first Bluetooth device set and the M second Bluetooth devices originally belonging to the second Bluetooth device set may be successfully configured to be belonging to the target Bluetooth device set for collaborative use. The N first Bluetooth devices and the M second Bluetooth devices of the target Bluetooth device set may also be capable of restoring to be belonging to different Bluetooth device sets to be used independently. The usage of the Bluetooth devices may be configured dynamically and flexibly, thereby meeting the user's usage requirements.

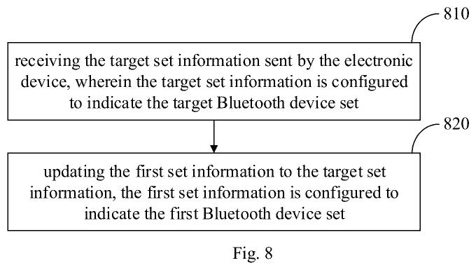

As illustrated in FIG. 8, in some embodiments, another information updating method is provided. This information updating method may be performed by the above-mentioned first Bluetooth devices. The method may include the following operations at blocks as illustrated in FIG. 8.

The operation at block 810: receiving the target set information sent by the electronic device, wherein the target set information is configured to indicate the target Bluetooth device set.

The operation at block 820: updating the first set information to the target set information, the first set information is configured to indicate the first Bluetooth device set. The N first Bluetooth devices that have updated the first set information to the target set information and the M second Bluetooth devices that have updated the second set information to the target set information are all recognized as belonging to the target Bluetooth device set; The second set information is configured to indicate the second Bluetooth device set. Both N and M are integers greater than 1.

In some embodiments, the target set information includes the target combination identification information. The target combination identification information is configured to identify the target Bluetooth device set. The target combination identification information is generated by the electronic device according to a preset approach; or the target combination identification information is the combination identification information stored in the electronic device; or, the target combination identification information is the combination identification information that is currently configured for the target Bluetooth device and obtained by the electronic device. The target Bluetooth device is any of the first Bluetooth devices or any of the second Bluetooth devices.

In some embodiments, in a case where the target combination identification information is generated by the electronic device according to the preset approach, the target combination identification information is generated by the electronic device based on the target BLE address. The target BLE address includes the BLE address of any of the first Bluetooth devices or the BLE address of any of the second Bluetooth devices. In some embodiments, the target combination identification information is the combination identification information randomly generated by the electronic device.

In some embodiments, the target Bluetooth device is the Bluetooth device from both the first Bluetooth device set and the second Bluetooth device set that firstly establishes the communicating connection with the electronic device.

In some embodiments, the target set information includes the number parameter and/or the serial number. The number parameter is configured to indicate the number of the Bluetooth devices included in the target Bluetooth device set. The number parameter is the sum of N and M. The serial number is configured to indicate the arrangement order for the Bluetooth device in the target Bluetooth device set.

In some embodiments, the electronic device includes the earphone case. Each of the N first Bluetooth devices includes the first left earphone and the first right earphone. The operation at block 810 includes: in a case where the first left earphone and the first right earphone are placed inside the earphone case, receiving the target set information sent by the earphone case.

In some embodiments, the method further includes: receiving the information restoration instruction sent by the electronic device; and restoring the target set information to the first set information according to the information restoration instruction.

In some embodiments, after the operation at block 820, the method further includes: sending the LE Audio broadcasting signal based on the target set information. The LE Audio broadcasting signal is configured to trigger an establishment of the LE Audio Bluetooth connection between the terminal device and the first Bluetooth device. The N first Bluetooth devices that establish the LE Audio Bluetooth connection with the terminal device, and the M second Bluetooth devices that establish the LE Audio Bluetooth connection with the terminal device share the audio data sent by the terminal device.

In some embodiments, each of the N first Bluetooth devices includes the first left earphone and the first right earphone, each of the M second Bluetooth devices include the second left earphone and the second right earphone. The first left earphone and the second left earphone share the left channel audio data sent by the terminal device, the first right earphone and the second right earphone share the right channel audio data sent by the terminal device.

The description of the information updating method provided in some embodiments of the present disclosure and performed by the first Bluetooth device may refer to the related description of the information updating method provided in the above-mentioned embodiments of the present disclosure and performed by the electronic device, which will not be elaborated herein.

In some embodiments of the present disclosure, the N first Bluetooth devices originally belonging to the first Bluetooth device set and the M second Bluetooth devices originally belonging to the second Bluetooth device set may all be successfully configured to be belonging to the target Bluetooth device set for collaborative use. The Bluetooth devices from different Bluetooth device set may be dynamically and flexibly grouped into a same Bluetooth device set for collaborative use, thereby meeting the user's usage requirements. In addition, the audio sharing between the N first Bluetooth devices and the M second Bluetooth devices may be achieved, the reliability of the audio data transmission may be enhanced.

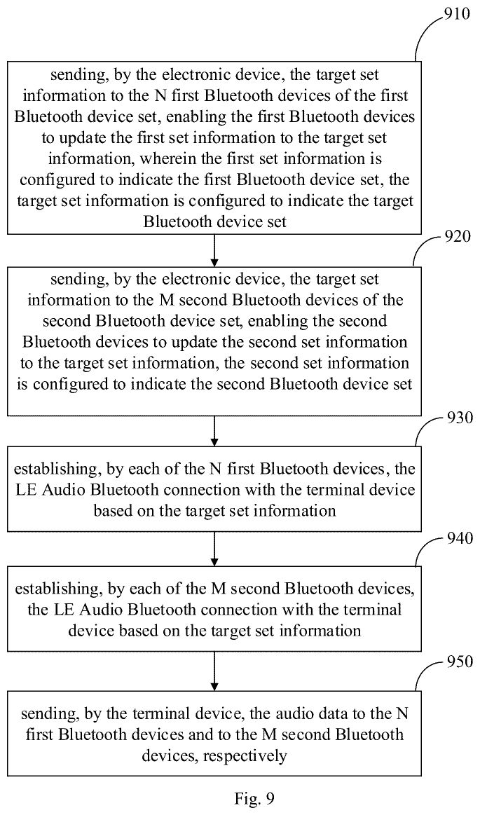

In some embodiments, the audio sharing method is provided. The audio sharing method may include the following operations at blocks as illustrated in FIG. 9.

The operation at block 910: sending, by the electronic device, the target set information to the N first Bluetooth devices of the first Bluetooth device set, enabling the first Bluetooth devices to update the first set information to the target set information. The first set information is configured to indicate the first Bluetooth device set. The target set information is configured to indicate the target Bluetooth device set. N is an integer greater than 1.

The operation at block 920: sending, by the electronic device, the target set information to the M second Bluetooth devices of the second Bluetooth device set, enabling the second Bluetooth devices to update the second set information to the target set information. The second set information is configured to indicate the second Bluetooth device set. M is an integer greater than 1.

In some embodiments, before the operation at block 910, the method further includes: obtaining, by the electronic device, the target set information.

In some embodiments, the operation in which obtaining, by the electronic device, the target set information includes: in a case of the first triggering operation, obtaining, by the electronic device, the target set information.

In some embodiments, the target set information includes the target combination identification information. The target combination identification information is configured to identify the target Bluetooth device set. The operation in which obtaining, by the electronic device, the target set information includes: generating, by the electronic device, the target combination identification information according to the preset approach; or, using, by the electronic device, the combination identification information stored in the electronic device as the target combination identification information; or, obtaining, by the electronic device, the combination identification information currently configured for the target Bluetooth device as the target combination identification information. Here, the target Bluetooth device is any of the first Bluetooth devices or any of the second Bluetooth devices.

In some embodiments, the operation in which generating, by the electronic device, the target combination identification information according to the preset approach includes: generating, by the electronic device and based on the target BLE address, the target combination identification information. The target BLE address includes the BLE address of any of the first Bluetooth devices or the BLE address of any of the second Bluetooth devices; or, randomly generating, by the electronic device, the combination identification information as the target combination identification information.

In some embodiments, the operation in which generating, by the electronic device, the target combination identification information based on the target BLE address includes: obtaining, by the electronic device, the target BLE address; taking the target BLE address as part of the fields of the target combination identification information to generate the target combination identification information; or, performing the hash calculation on the target BLE address, and taking the calculation result as part of the fields of the target combination identification information to generate the target combination identification information.

In some embodiments, the target Bluetooth device is the Bluetooth device from both the first Bluetooth device set and the second Bluetooth device set that firstly establishes the communicating connection with the electronic device.

In some embodiments, the target set information includes the number parameter and/or the serial number. The number parameter is configured to indicate the number of the Bluetooth devices that are included in the target Bluetooth device set. The number parameter is the sum of N and M. The serial number is configured to indicate the arrangement order for the Bluetooth device in the target Bluetooth device set.

The operation at block 930: establishing, by each of the N first Bluetooth devices, the LE Audio Bluetooth connection with the terminal device based on the target set information.

The operation at block 940: establishing, by each of the M second Bluetooth devices, the LE Audio Bluetooth connection with the terminal device based on the target set information.

The operation at block 950: sending, by the terminal device, the audio data to the N first Bluetooth devices and to the M second Bluetooth devices, respectively.

In some embodiments, the electronic device includes the earphone case, each of the N first Bluetooth devices include the first left earphone and the first right earphone, each of the M second Bluetooth devices include the second left earphone and the second right earphone.

The operation at block 910 includes: in a case where the first left earphone and the first right earphone are both placed inside the earphone case, sending, by the earphone case, the target set information to the first left earphone and to the first right earphone respectively.

The operation at block 920 includes: in a case where the second left earphone and the second right earphone are both placed inside the earphone case, sending, by the earphone case, the target set information to the second left earphone and to the second right earphone respectively.

The operation at block 950 includes: sending, by the terminal device, the left channel audio data to the first left earphone and to the second left earphone respectively, and sending, by the terminal device, the right channel audio data to the first left earphone and to the second right earphone respectively.

In some embodiments, the method further includes: in a case of the second triggering operation, sending, by the electronic device, the information restoration instruction to the N first Bluetooth devices, wherein the information restoration instruction is configured to instruct the first Bluetooth device to restore the target set information to the first set information; and/or, sending the information restoration instruction to the M second Bluetooth devices, wherein the information restoration instruction is configured to instruct the second Bluetooth device to restore the target set information to the second set information.

The description of the audio sharing method provided in the present disclosure may refer to the related description of the information updating method performed by the electronic device and provided in some embodiments of the present disclosure, and will not be elaborated herein.

In some embodiments of the present disclosure, the N first Bluetooth devices originally belonging to the first Bluetooth device set and the M second Bluetooth devices originally belonging to the second Bluetooth device set may be successfully configured to be belonging to the target Bluetooth device set for collaborative use. The Bluetooth devices from different Bluetooth device set may be dynamically and flexibly grouped into a same Bluetooth device set for collaborative use, thereby meeting the user's usage requirements. In addition, the audio sharing between the N first Bluetooth devices and the M second Bluetooth devices may be achieved, and the reliability of the audio data transmission may be enhanced.

In some embodiments, an audio sharing system is provided. This system includes the electronic device, the N first Bluetooth devices, the M second Bluetooth devices and the terminal device. Both N and M are integers greater than 1.

The electronic device is configured to send the target set information to the N first Bluetooth devices of the first Bluetooth device set, enabling the first Bluetooth devices to update the first set information to the target set information. The first set information is configured to indicate the first Bluetooth device set. The target set information is configured to indicate the target Bluetooth device set.

The electronic device is further configured to send the target set information to the M second Bluetooth devices of the second Bluetooth device set, enabling the second Bluetooth devices to update the second set information to the target set information. The second set information is configured to indicate the second Bluetooth device set.

Each of the N first Bluetooth devices is configured to establish the LE Audio Bluetooth connection with the terminal device based on the target set information.

Each of the M second Bluetooth devices is configured to establish the LE Audio Bluetooth connection with the terminal device based on the target set information.

The terminal device is configured to send the audio data to the N first Bluetooth devices and to the M second Bluetooth devices respectively.

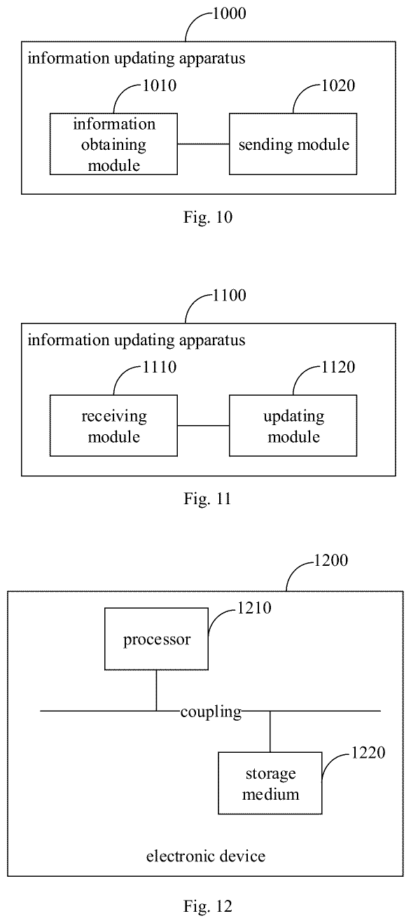

As illustrated in FIG. 10, in some embodiments, an information updating apparatus 1000 that may be applied in the above-mentioned electronic device is provided. The information updating apparatus 1000 includes an information obtaining module 1010 and a sending module 1020.

The information obtaining module 1010 is configured to obtain the target set information. The target set information is configured to indicate the target Bluetooth device set.

The sending module 1020 is configured to send the target set information to the N first Bluetooth devices of the first Bluetooth device set, enabling the first Bluetooth device to update the first set information to the target set information. The first set information is configured to indicate the first Bluetooth device set. N is an integer greater than 1.

The sending module 1020 is further configured to send the target set information to the M second Bluetooth devices of the second Bluetooth device set, enabling the second Bluetooth device to update the second set information to the target set information. The second set information is configured to indicate the second Bluetooth device set. M is an integer greater than 1.

In some embodiments, the information obtaining module 1010 is further configured to obtain, in a case of the first triggering operation, the target set information.

In some embodiments, the target set information includes the target combination identification information. The target combination identification information is configured to identify the target Bluetooth device set. The information obtaining module 1010 is further configured to: generate the target combination identification information according to a preset approach; or, take the combination identification information stored in the electronic device as the target combination identification information; or, obtain the combination identification information currently configured for the target Bluetooth device as the target combination identification information, the target Bluetooth device being any of the first Bluetooth devices or any of the second Bluetooth devices.

In some embodiments, the information obtaining module 1010 is further configured to generate the target combination identification information based on the target BLE address, wherein the target BLE address includes the BLE address of any of the first Bluetooth devices or the BLE address of any of the second Bluetooth devices; or, randomly generating the combination identification information as the target combination identification information.

In some embodiments, the information obtaining module 1010 is further configured to obtain the target BLE address; take the target BLE address as part of the fields of the target combination identification information to generate the target combination identification information; or, perform the hash calculation on the target BLE address, and take the calculation result as part of the fields of the target combination identification information to generate the target combination identification information.

In some embodiments, the target Bluetooth device is the Bluetooth device from both the first Bluetooth device set and the second Bluetooth device set that firstly establishes the communicating connection with the electronic device.

In some embodiments, the target set information includes the number parameter and/or the serial number. The number parameter is configured to indicate the number of the Bluetooth devices included in the target Bluetooth device set. The number parameter is the sum of N and M. The serial number is configured to indicate the arrangement order for the Bluetooth device in the target Bluetooth device set.

In some embodiments, the electronic device includes the earphone case. Each of the N first Bluetooth devices of the first Bluetooth device set includes the first left earphone and the first right earphone, each of the M second Bluetooth devices of the second Bluetooth device set includes the second left earphone and the second right earphone. The sending module 1020 is further configured to: in a case where the first left earphone and the first right earphone are placed inside the earphone case, send the target set information to the first left earphone and to the first right earphone respectively. The sending module 1020 is further configured to: in a case where the second left earphone and the second right earphone are placed inside the earphone case, send the target set information to the second left earphone and to the second right earphone respectively.

In some embodiments, in addition to including the information obtaining module 1010 and the sending module 1020, the information updating apparatus 1000 further includes a restoration module.

The restoration module is configured to: in a case of the second triggering operation, send the information restoration instruction to the N first Bluetooth devices, wherein the information restoration instruction is configured to instruct the first Bluetooth device to restore the target set information to the first set information; and/or, send the information restoration instruction to the M second Bluetooth devices, wherein the information restoration instruction is configured to instruct the second Bluetooth device to restore the target set information to the second set information.

As illustrated in FIG. 11, in some embodiments, an information updating apparatus 1100 that may be applied in the above-mentioned first Bluetooth device is provided. The information updating apparatus 1100 includes a receiving module 1110 and an updating module 1120.

The receiving module 1110 is configured to receive the target set information sent by the electronic device. The target set information is configured to indicate the target Bluetooth device set.

The updating module 1120 is configured to update the first set information to the target set information. The first set information is configured to indicate the first Bluetooth device set. The N first Bluetooth devices that have updated the first set information to the target set information and the M second Bluetooth devices that have updated the second set information to the target set information are recognized as belonging to the target Bluetooth device set. The second set information is configured to indicate the second Bluetooth device set. Both N and M are integers greater than 1.

In some embodiments, the target set information includes the target combination identification information. The target combination identification information is configured to identify the target Bluetooth device set.

The target combination identification information is generated by the electronic device according to a preset approach; or, the target combination identification information is the combination identification information stored in the electronic device; or, the target combination identification information is the combination identification information that is currently configured for the target Bluetooth device and obtained by the electronic device. The target Bluetooth device is any of the first Bluetooth devices or any of the second Bluetooth devices.

In some embodiments, in a case where the target combination identification information is generated by the electronic device according to the preset approach, the target combination identification information is generated by the electronic device based on the target BLE address. The target BLE address includes the BLE address of any of the first Bluetooth devices or the BLE address of any of the second Bluetooth devices. In some embodiments, the target combination identification information is the combination identification information randomly generated by the electronic device.

In some embodiments, the target Bluetooth device is the Bluetooth device from both the first Bluetooth device set and the second Bluetooth device set that firstly establishes the communicating connection with the electronic device.

In some embodiments, the target set information includes the number parameter and/or the serial number. The number parameter is configured to indicate the number of the Bluetooth devices that are included in the target Bluetooth device set. The number parameter is the sum of N and M. The serial number is configured to indicate the arrangement order for the Bluetooth device in the target Bluetooth device set.

In some embodiments, the electronic device includes the earphone case. Each of the N first Bluetooth devices includes the first left earphone and the first right earphone. The receiving module 1110 is further configured to: in a case where the first left earphone and the first right earphone are placed inside the earphone case, receive the target set information sent by the earphone case.

In some embodiments, in addition to including the receiving module 1110 and the updating module 1120, the information updating apparatus 1100 further includes the restoration module.

The restoration module is configured to: receive the information restoration instruction sent by the electronic device; restore the target set information to the first set information according to the information restoration instruction.

In some embodiments, the information updating apparatus 1100 further includes a broadcasting module.

The broadcasting module is configured to send the LE Audio broadcasting signal based on the target set information. The LE Audio broadcasting signal is configured to trigger the establishment of the LE Audio Bluetooth connection between the terminal device and the first Bluetooth device. The N first Bluetooth devices that have established the LE Audio Bluetooth connection with the terminal device, and the M second Bluetooth devices that have established the LE Audio Bluetooth connection with the terminal device share the audio data sent by the terminal device.

In some embodiments, each of the N first Bluetooth devices includes the first left earphone and the first right earphone, each of the M second Bluetooth devices includes the second left earphone and the second right earphone. The first left earphone and the second left earphone share the left channel audio data sent by the terminal device. The first right earphone and the second right earphone share the right channel audio data sent by the terminal device.

In some embodiments of the present disclosure, the N first Bluetooth devices originally belonging to the first Bluetooth device set and the M second Bluetooth devices originally belonging to the second Bluetooth device set may all be successfully configured to be belonging to the target Bluetooth device set for collaborative use. The Bluetooth devices from different Bluetooth device set may be dynamically and flexibly grouped into the same Bluetooth device set for collaborative use, thereby meeting the user's usage requirements. In addition, the audio sharing between the N first Bluetooth devices and the M second Bluetooth devices may be achieved, the reliability of the audio data transmission may thus be enhanced.

FIG. 12 is a structural block diagram of the electronic device according to an embodiment of the present disclosure. As illustrated in FIG. 12, the electronic device 1200 may include one or more of the following components: a processor 1210, and a memory 1220 coupled with the processor 1210. The memory 1220 may store one or more computer program. The one or more computer program may be configured to, when being executed by the one or more processor 1210, implement the information updating method that is performed by the electronic device and is described in the above-mentioned various embodiments.

The processor 1210 may include one or more processing cores. The processor 1210 may be connected to various portions within the entire electronic device 1200 via a variety of interfaces and wiring, and may perform various functions of the electronic device 1200 and process data by running or executing instructions, programs, code sets, or instruction sets stored in the memory 1220, as well as by calling up data stored in the memory 1220. In some embodiments, the processor 1210 may be implemented in at least one hardware form of a digital signal processing (DSP), a field-programmable gate array (FPGA), and a programmable logic array (PLA). One or a combination of multiple ones selected from the group consisting of a central processing unit (CPU), a graphics processing unit (GPU), a modem, or the like may be integrated into the processor 1210. The CPU mainly deals with operating systems, user interfaces and applications, etc. The GPU is configured for rendering and drawing of display contents. The modem is configured to deal with wireless communication. The above-mentioned modem may also be realized via a separate communication chip, and without being integrated into the processor 1210.

The memory 1220 may include a random-access memory (RAM), or may include a read-only memory (ROM). The memory 1220 may be configured to store instructions, programs, codes, code sets or instruction sets. The memory 1220 may include a program storage area and a data storage area. The program storage area may be configured to store: instructions for implementing the operating system; instructions for achieving at least one function (e.g., a touch control function, a sound play function, an image display function, etc.); instructions for implementing each of the method embodiments described above; or the like. The data storage area may further store data created by the electronic device 1200 during usage, or the like.

The electronic device 1200 may also include a communication unit. The communication unit may for example be a Bluetooth module. The Bluetooth module may be configured to: provide a Bluetooth communication function; establish a Bluetooth connection with the second electronic device; and, perform the Bluetooth data transmission. The Bluetooth module may support, without limitation, one or more kinds of Bluetooth protocols, such as the classic Bluetooth, the BLE, the BLE Audio, or the like. The specially supported Bluetooth protocols may evolve with the development of Bluetooth protocols.

The present disclosure provides the Bluetooth device. The Bluetooth device includes a memory, a processor and a communication unit. The memory stores a computer program. This computer program, when being executed by the processor, enables the Bluetooth device to implement the information updating method performed by the first Bluetooth device and described in the above-mentioned embodiments.

The embodiments of the present disclosure provide a non-transitory computer-readable storage medium. The computer-readable storage medium stores the computer program. This computer program, when being executed by the processor of the electronic device, enables the electronic device to implement the information updating method performed by the electronic device and described in the above-mentioned embodiments.

The embodiments of the present disclosure provide a computer-readable storage medium computer-readable storage medium stores a computer program. This computer program, when being executed by the processor of the electronic device, enables the electronic device to implement the information updating method performed by the first Bluetooth device and described in the above-mentioned embodiments.

A computer program product may be provided in the embodiments of the present disclosure. This computer program product includes a non-transitory computer-readable storage medium that stores a computer program. This computer program, when being executed by the processor of the electronic device, may enable the electronic device to implement the information updating method performed by the electronic device and described in the above-mentioned embodiments.

A computer program product may be provided in the embodiments of the present disclosure. This computer program product includes a non-transitory computer-readable storage medium that stores a computer program. This computer program, when being executed by the processor of the electronic device, may enable the electronic device to implement the information updating method performed by the first Bluetooth device and described in the above-mentioned embodiments.

Those of ordinary skills in the art may appreciate that, all or a part of the process for implementing the method in the above-mentioned embodiments may be done by instructing the relevant hardware through a computer program. The computer program may be stored in the non-volatile computer-readable storage medium. This program, when being executed, may include the processes of the embodiments of the above-mentioned various methods. The recited storage medium may be a magnetic disk, an optical disk, a ROM, or the like.

Any reference to a memory, a storage, a database or other media made in the embodiments herein may include a non-volatile memory and/or a volatile memory. Suitable non-volatile memory may include an ROM, a programmable ROM (PROM), an erasable PROM (EPROM), an electrically erasable PROM (EEPROM), or a flash memory. The volatile memory may include an RAM, which may be configured as an external cache memory. As illustration but not limitation, RAM may have many kinds of forms, such as a static RAM (SRAM), a dynamic random-access memory (DRAM), a synchronous DRAM (SDRAM), a double data rate SDRAM (DDR SDRAM), an enhanced synchronous DRAM (ESDRAM), a Synchlink DRAM (SLDRAM), a Rambus DRAM (RDRAM) and a direct Rambus DRAM (DRDRAM).

Reference to “an embodiment” or “embodiments” throughout the specification means that a particular feature, structure or characteristic described in conjunction with the embodiment is included in at least one embodiment of the present disclosure. Therefore, the phrase “in one embodiment” or “in some embodiments” found throughout the specification does not necessarily refer to the same embodiment. In addition, these certain features, structures or characteristics may be combined in one or more embodiments in any appropriate manner. Those skilled in the art should also learn that, the embodiments described in the specification are all optional embodiments, and the actions and modules involved are not necessarily required for the present disclosure. In the present disclosure, “a plurality of” means two or more than two.

In various embodiments of the present disclosure, the order of the sequence numbers of the various processes described above does not imply the necessary sequence of execution, and the sequence of execution of the processes should be determined by their function and inherent logic, and should not constitute any limitation on the processes implemented in the embodiments of the present disclosure.

The above-mentioned units illustrated as separate components may or may not be physically separate, and the components illustrated as units may or may not be physical units. The units may be located in one place or may be distributed on multiple network units. Some or all of the units may be selected as per actual needs to fulfill the object of the implementation of the present embodiment.

In addition, each functional unit in embodiments of the present disclosure may be integrated into one processing unit, or may be physically separate units, or two or more units may be integrated into one unit. The above-mentioned integrated units may be embodied in the form of hardware or software functional unit.

Technical features of the above-mentioned embodiments could be combined arbitrarily. In order to make the description concise, not all possible combinations of the various technical features in the above-mentioned embodiments are described. However, as long as there is no contradiction in the combination of these technical features, all should be considered to be within the scope of the specification.

The information updating method and the information updating apparatus, the audio sharing method and the audio sharing system, the electronic device provided in embodiments of the present disclosure are described in detail above. The principle and implementation of the present disclosure are illustrated in the present disclosure by means of specific embodiments. The illustration of the above embodiments is only for facilitating the understanding the method and its core idea of the present disclosure. Meanwhile, according to the idea of the present disclosure, specific implementation and its application scope may be changed by those of ordinary skills in the art. In summary, the contents of the specification should not be construed as a limitation on the present disclosure.

What is claimed is:

1. An information updating method, performed by an electronic device, and comprising:
obtaining target set information, wherein the target set information is configured to indicate a target Bluetooth device set;
sending the target set information to N first Bluetooth devices of a first Bluetooth device set, enabling the first Bluetooth devices to update first set information to the target set information, wherein the first set information is configured to indicate the first Bluetooth device set, N is an integer greater than 1; and
sending the target set information to M second Bluetooth devices of a second Bluetooth device set, enabling the second Bluetooth devices to update second set information to the target set information, wherein the second set information is configured to indicate the second Bluetooth device set, M is an integer greater than 1.

2. The method as claimed in claim 1, wherein
the target set information comprises target combination identification information, the target combination identification information is configured to identify the target Bluetooth device set;
the obtaining the target set information comprises:
generating the target combination identification information according to a preset approach; or
using combination identification information stored in the electronic device as the target combination identification information; or
obtaining combination identification information currently configured for the target Bluetooth device as the target combination identification information, wherein the target Bluetooth device is any one of the first Bluetooth devices or any one of the second Bluetooth devices.

3. The method as claimed in claim 2, wherein
the generating the target combination identification information according to the preset approach comprises:
generating the target combination identification information based on a target Bluetooth low energy (BLE) address, wherein the target BLE address comprises a BLE address of any one of the first Bluetooth devices or the BLE address of any one of the second Bluetooth devices; or
randomly generating combination identification information as the target combination identification information.

4. The method as claimed in claim 3, wherein
the generating the target combination identification information based on the target BLE address comprises:
obtaining the target BLE address;
taking the target BLE address as part of fields of the target combination identification information to generate the target combination identification information; or
performing a hash calculation on the target BLE address, and taking the calculation result as the part of the fields of the target combination identification information to generate the target combination identification information.

5. The method as claimed in claim 2, wherein
the target Bluetooth device is a Bluetooth device from both the first Bluetooth device set and the second Bluetooth device set that firstly establishes a communicating connection with the electronic device.

6. The method as claimed in claim 2, wherein
the target combination identification information comprises a target set identity resolving key (SIRK).

7. The method as claimed in claim 1, wherein
the target set information comprises a number parameter and/or a serial number;
the number parameter is configured to indicate the number of Bluetooth devices included in the target Bluetooth device set, the number parameter is a sum of N and M; and
the serial number is configured to indicate an arrangement order for the Bluetooth device in the target Bluetooth device set.

8. The method as claimed in claim 1, wherein
the obtaining the target set information comprises:
obtaining, in a case of a first triggering operation, the target set information.

9. The method as claimed in claim 1, wherein
the electronic device comprises an earphone case, the N first Bluetooth devices of the first Bluetooth device set comprise a first left earphone and a first right earphone, the M second Bluetooth devices of the second Bluetooth device set comprise a second left earphone and a second right earphone;
wherein the sending the target set information to the N first Bluetooth devices of the first Bluetooth device set comprises:
in a case where the first left earphone and the first right earphone are placed inside the earphone case, sending, by the earphone case, the target set information to the first left earphone and to the first right earphone respectively;
wherein the sending the target set information to the M second Bluetooth devices of the second Bluetooth device set comprises:
in a case where the second left earphone and the second right earphone are placed inside the earphone case, sending, by the earphone case, the target set information to the second left earphone and to the second right earphone respectively; or
the electronic device comprises a terminal device,
wherein the sending the target set information to the N first Bluetooth devices of the first Bluetooth device set comprises:
sending, by the terminal device, the target set information to the N first Bluetooth devices of the first Bluetooth device;
wherein the sending the target set information to the M second Bluetooth devices of the second Bluetooth device set comprises:
sending, by the terminal device, the target set information to the M second Bluetooth devices of the second Bluetooth device set.

10. The method as claimed in claim 1, further comprising:
in a case of a second triggering operation:
sending an information restoration instruction to the N first Bluetooth devices, wherein the information restoration instruction is configured to instruct the first Bluetooth devices to restore the target set information to the first set information; and/or
sending the information restoration instruction to the M second Bluetooth devices, wherein the information restoration instruction is configured to instruct the second Bluetooth devices to restore the target set information to the second set information.

11. An information updating method, performed by a first Bluetooth device, and comprising:
receiving target set information sent by an electronic device, wherein the target set information is configured to indicate a target Bluetooth device set; and
updating first set information to the target set information, wherein the first set information is configured to indicate a first Bluetooth device set;
wherein N first Bluetooth devices that have updated the first set information to the target set information and M second Bluetooth devices that have updated second set information to the target set information are all recognized as belonging to the target Bluetooth device set, wherein the second set information is configured to indicate a second Bluetooth device set, both N and M are integers greater than 1.

12. The method as claimed in claim 11, wherein
the target set information comprises a number parameter and/or a serial number, the number parameter is configured to indicate the number of Bluetooth devices included in the target Bluetooth device set, the number parameter is the sum of the N and the M; and
the serial number is configured to indicate an arrangement order for a Bluetooth device in the target Bluetooth device set.

13. The method as claimed in claim 11, wherein
the electronic device comprises an earphone case, the N first Bluetooth devices comprise a first left earphone and a first right earphone;
the receiving the target set information sent by the electronic device comprises:
in a case where the first left earphone and the first right earphone are placed inside the earphone case, receiving the target set information sent by the earphone case.

14. The method as claimed in claim 11, further comprising:
receiving an information restoration instruction sent by the electronic device; and
restoring the target set information to the first set information according to the information restoration instruction.

15. The method as claimed in claim 11, wherein
after the updating the first set information to the target set information, the method further comprises:
sending an LE Audio broadcasting signal based on the target set information, wherein the LE Audio broadcasting signal is configured to trigger an establishment of an LE Audio Bluetooth connection between a terminal device and the first Bluetooth device;
wherein the N first Bluetooth devices that establish the LE Audio Bluetooth connection with the terminal device share, with the M second Bluetooth devices that establish the LE Audio Bluetooth connection with the terminal device, audio data sent by the terminal device.

16. The method as claimed in claim 15, wherein
the N first Bluetooth devices comprise a first left earphone and a first right earphone, the M second Bluetooth devices comprise a second left earphone and a second right earphone, the first left earphone and the second left earphone share left channel audio data sent by the terminal device, and the first right earphone and the second right earphone share right channel audio data sent by the terminal device.

17. An electronic device, comprising a memory, a processor and a communication unit, wherein
the memory stores a computer program;
the computer program, when being executed by the processor, enables the electronic device to implement an information updating method,
the information updating method comprises:
obtaining target set information, wherein the target set information is configured to indicate a target Bluetooth device set;
sending the target set information to N first Bluetooth devices of a first Bluetooth device set, enabling the first Bluetooth devices to update first set information to the target set information, wherein the first set information is configured to indicate the first Bluetooth device set, N is an integer greater than 1; and
sending the target set information to M second Bluetooth devices of a second Bluetooth device set, enabling the second Bluetooth devices to update second set information to the target set information, wherein the second set information is configured to indicate the second Bluetooth device set, M is an integer greater than 1.

18. The electronic device as claimed in claim 17, wherein
the target set information comprises target combination identification information, the target combination identification information is configured to identify the target Bluetooth device set;
the obtaining the target set information comprises:
generating the target combination identification information according to a preset approach; or
using combination identification information stored in the electronic device as the target combination identification information; or
obtaining combination identification information currently configured for the target Bluetooth device as the target combination identification information, wherein the target Bluetooth device is any one of the first Bluetooth devices or any one of the second Bluetooth devices.

19. The electronic device as claimed in claim 18, wherein
the generating the target combination identification information according to the preset approach comprises:
generating the target combination identification information based on a target BLE address, wherein the target BLE address comprises a BLE address of any one of the first Bluetooth devices or the BLE address of any one of the second Bluetooth devices; or
randomly generating combination identification information as the target combination identification information.

20. The electronic device as claimed in claim 19, wherein
the generating the target combination identification information based on the target BLE address comprises:
obtaining the target BLE address;
taking the target BLE address as part of fields of the target combination identification information to generate the target combination identification information; or
performing a hash calculation on the target BLE address, and taking the calculation result as the part of the fields of the target combination identification information to generate the target combination identification information.
